(19) United States
(12) Patent Application Publication
(10) Pub. No.: US 2013/0281131 A1
(43) Pub. Date: Oct. 24, 2013

(54) WIRELESS COMMUNICATION APPARATUS, WIRELESS COMMUNICATION SYSTEM, WIRELESS COMMUNICATION METHOD, AND COMPUTER-READABLE RECORDING MEDIUM

(71) Applicant: OLYMPUS CORPORATION, Tokyo (JP)

(72) Inventor: Yasuhiro Hasegawa, Hanno-shi (JP)

(73) Assignee: OLYMPUS CORPORATION, Tokyo (JP)

(21) Appl. No.: 13/864,843

(22) Filed: Apr. 17, 2013

(30) Foreign Application Priority Data
Apr. 20, 2012 (JP) 2012-096985

(51) Int. Cl. H04W 52/02

(52) U.S. Cl. CPC H04W 52/0251
USPC 455/456.4

(57) ABSTRACT

A wireless communication apparatus are possible to reduce power consumption, and a wireless communication unit operates in one of a first standby state and a first activation state in which power consumption is higher than that in the first standby state, wirelessly transmits data to an external terminal different from its own terminal when operating in the first activation state, and operates in the first standby state after transmission of the data ends. An activation signal generation circuit operates in one of a second standby state and a second activation state in which power consumption is higher than that in the second standby state, repeats an operation in the second activation state and an operation in the second standby state at a predetermined time interval, and outputs a shift signal for shifting an operation of the communication module from the first standby state to the first activation state.

### BACKGROUND OF THE INVENTION

1. Field of the Invention

The present invention relates to a wireless communication apparatus, a wireless communication system, a wireless communication method, and a program.

The application is based on and claims the benefit of priority from prior Japanese Patent Application No. 2012-096985, filed Apr. 20, 2012, the entire contents of which are incorporated herein.

2. Description of Related Art

In the medical and health care fields, there has been an increased effort to collect biological data from the surface of the human body or the inside of the body using a terminal provided with various sensors, transmit the biological data collected by the terminal to an accumulation device for accumulation, and use the biological data accumulated in the accumulation device for health management, disease diagnosis, medical treatment and the like. For this purpose, if the terminal is connected to the accumulation device using a wired cable in order to transmit the biological data, since the freedom of movement is limited, it is preferable to transmit the biological data through wireless communication, and to allow a user to freely carry the terminal. These needs are significantly increased in the medical field, particularly, for an implantable medical device.

However, in such a wireless communication system, since data is transmitted by radio, a communication error may occur by various types of interference. Therefore, it is desired to solve such a problem. For such a desire, in a wireless communication apparatus that performs data communication with a predetermined time cycle, a wireless communication apparatus changing a transmission cycle based on a battery level has been known (for example, refer to Japanese Patent No. 4343160)

### SUMMARY OF THE INVENTION

According to a first aspect of the present invention, a wireless communication apparatus includes: a communication module that operates in one of a first standby state and a first activation state in which power consumption is higher than power consumption in the first standby state, wirelessly transmits data to an external terminal different from its own terminal when operating in the first activation state, and operates in the first standby state after transmission of the data ends; an activation signal generation unit that operates in one of a second standby state and a second activation state in which power consumption is higher than power consumption in the second standby state, repeats an operation in the second activation state and an operation in the second standby state at a predetermined time interval, and outputs a shift signal for shifting an operation of the communication module from the first standby state to the first activation state if an activation signal is received from the external terminal when operating in the second activation state; and a cycle decision unit that changes the predetermined time interval based on location information indicating whether an estimation position of its own terminal or an estimation position of the external terminal is within a predetermined location range.

Furthermore, according to a second aspect of the present invention, the wireless communication apparatus according to the first aspect further includes an acquisition unit that acquires the location information, and the cycle decision unit changes the predetermined time interval based on the location information acquired by the acquisition unit.

Furthermore, according to a third aspect of the present invention, in the wireless communication apparatus of the second aspect, the acquisition unit acquires the location information from the external terminal.

Furthermore, according to a fourth aspect of the present invention, in the wireless communication apparatus of the second aspect, the acquisition unit acquires the location information from the Global Positioning System.

Furthermore, according to a fifth aspect of the present invention, in the wireless communication apparatus of the second aspect, the acquisition unit operates with power consumption is lower than power consumption of the communication module operating in the first activation state, detects presence of a predetermined apparatus, and acquires the location information based on a result of the detection.

Furthermore, according to a sixth aspect of the present invention, the wireless communication apparatus of the first aspect further includes a cycle storage unit that stores time information corresponding to the location information as an operation cycle table, and the cycle decision unit decides the location information based on the operation cycle table stored in the cycle storage unit and a current time.

Furthermore, according to a seventh aspect of the present invention, the wireless communication system includes: a first communication module that operates in one of a first standby state and a first activation state in which power consumption is higher than power consumption in the first standby state, wirelessly transmits data to an external terminal different from its own terminal when operating in the first activation state, and operates in the first standby state after transmission of the data ends; a first activation signal generation unit that operates in one of a second standby state and a second activation state in which power consumption is higher than power consumption in the second standby state, repeats an operation in the second activation state and an operation in the second standby state at a predetermined time interval, and outputs a shift signal for shifting an operation of the first communication module from the first standby state to the first activation state if an activation signal is received from the external terminal when operating in the second activation state; a cycle decision unit that changes the predetermined time interval based on location information indicating whether an estimation position of its own terminal or an estimation position of the external terminal is within a predetermined location range; a second communication module that receives the data transmitted by the first communication module; and a second activation signal generation unit that transmits the activation signal to the first activation signal generation unit.

Furthermore, according to an eighth aspect of the present invention, a wireless communication apparatus is included in a wireless communication system including a first communication module that operates in one of a first standby state and a first activation state in which power consumption is higher than power consumption in the first standby state, wirelessly transmits data to an external terminal different from its own terminal when operating in the first activation state, and operates in the first standby state after transmission of the data ends, a first activation signal generation unit that operates in one of a second standby state and a second activation state in which power consumption is higher than power consumption in the second standby state, repeats an operation in the second activation state and an operation in the second standby state at a predetermined time interval, and outputs a shift signal for shifting an operation of the first communication module from the first standby state to the first activation state if an activation signal is received from the external terminal when operating in the second activation state, a cycle decision unit that changes the predetermined time interval based on location information indicating whether an estimation position of its own terminal or an estimation position of the external terminal is within a predetermined location range, a second communication module that receives the data transmitted by the first communication module, and a second activation signal generation unit that transmits the activation signal to the first activation signal generation unit, and includes: the second communication module; and the second activation signal generation unit.

Furthermore, according to a ninth aspect of the present invention, the wireless communication apparatus according to the eighth aspect further includes the cycle decision unit.

Furthermore, according to a tenth aspect of the present invention, a wireless communication apparatus is included in a wireless communication system including a first communication module that operates in one of a first standby state and a first activation state in which power consumption is higher than power consumption in the first standby state, wirelessly transmits data to an external terminal different from its own terminal when operating in the first activation state, and operates in the first standby state after transmission of the data ends, a first activation signal generation unit that operates in one of a second standby state and a second activation state in which power consumption is higher than power consumption in the second standby state, repeats an operation in the second activation state and an operation in the second standby state at a predetermined time interval, and outputs a shift signal for shifting an operation of the first communication module from the first standby state to the first activation state if an activation signal is received from the external terminal when operating in the second activation state, a cycle decision unit that changes the predetermined time interval based on location information indicating whether an estimation position of its own terminal or an estimation position of the external terminal is within a predetermined location range, a second communication module that receives the data transmitted by the first communication module, and a second activation signal generation unit that transmits the activation signal to the first activation signal generation unit, and includes: the first communication module, the first activation signal generation unit, and the cycle decision unit.

Furthermore, according to an eleventh aspect of the present invention, a wireless communication method includes: a communication step in which a communication module operates in one of a first standby state and a first activation state in which power consumption is higher than power consumption in the first standby state, wirelessly transmits data to an external terminal different from its own terminal when operating in the first activation state, and operates in the first standby state after transmission of the data ends; an activation signal generation step in which an activation signal generation unit operates in one of a second standby state and a second activation state in which power consumption is higher than power consumption in the second standby state, repeats an operation in the second activation state and an operation in the second standby state at a predetermined time interval, and outputs a shift signal for shifting an operation of the communication module from the first standby state to the first activation state if an activation signal is received from the external terminal when operating in the second activation state; and a cycle decision step in which a cycle decision unit changes the predetermined time interval based on location information indicating whether an estimation position of its own terminal or an estimation position of the external terminal is within a predetermined location range.

Furthermore, according to a twelfth aspect of the present invention, a wireless communication method includes: a first communication step in which a first communication module operates in one of a first standby state and a first activation state in which power consumption is higher than power consumption in the first standby state, wirelessly transmits data to an external terminal different from its own terminal when operating in the first activation state, and operates in the first standby state after transmission of the data ends; a first activation signal generation step in which a first activation signal generation unit operates in one of a second standby state and a second activation state in which power consumption is higher than power consumption in the second standby state, repeats an operation in the second activation state and an operation in the second standby state at a predetermined time interval, and outputs a shift signal for shifting an operation of the first communication module from the first standby state to the first activation state if an activation signal is received from the external terminal when operating in the second activation state; a cycle decision step in which a cycle decision unit changes the predetermined time interval based on location information indicating whether an estimation position of its own terminal or an estimation position of the external terminal is within a predetermined location range; a second communication step in which a second communication module receives the data transmitted by the first communication module; and a second activation signal generation step in which a second activation signal generation unit transmits the activation signal to the first activation signal generation unit.

Furthermore, according to a thirteenth aspect of the present invention, a computer-readable recording medium recording a program causes a computer to execute: a communication step in which a communication module operates in one of a first standby state and a first activation state in which power consumption is higher than power consumption in the first standby state, wirelessly transmits data to an external terminal different from its own terminal when operating in the first activation state, and operates in the first standby state after transmission of the data ends; an activation signal generation step in which an activation signal generation unit operates in one of a second standby state and a second activation state in which power consumption is higher than power consumption in the second standby state, repeats an operation in the second activation state and an operation in the second standby state at a predetermined time interval, and outputs a shift signal for shifting an operation of the communication module from the first standby state to the first activation state if an activation signal is received from the external terminal when operating in the second activation state; and a cycle decision step in which a cycle decision unit changes the predetermined time interval based on location information indicating whether an estimation position of its own terminal or an estimation position of the external terminal is within a predetermined location range.

Furthermore, according to a fourteenth aspect of the present invention, a computer-readable recording medium recording a program causes a computer to execute: a first communication step in which a first communication module operates in one of a first standby state and a first activation state in which power consumption is higher than power consumption in the first standby state, wirelessly transmits data to an external terminal different from its own terminal when operating in the first activation state, and operates in the first standby state after transmission of the data ends; a first activation signal generation step in which a first activation signal generation unit operates in one of a second standby state and a second activation state in which power consumption is higher than power consumption in the second standby state, repeats an operation in the second activation state and an operation in the second standby state at a predetermined time interval, and outputs a shift signal for shifting an operation of the first communication module from the first standby state to the first activation state if an activation signal is received from the external terminal when operating in the second activation state; a cycle decision step in which a cycle decision unit changes the predetermined time interval based on location information indicating whether an estimation position of its own terminal or an estimation position of the external terminal is within a predetermined location range; a second communication step in which a second communication module receives the data transmitted by the first communication module; and a second activation signal generation step in which a second activation signal generation unit transmits the activation signal to the first activation signal generation unit.

### BRIEF DESCRIPTION OF THE DRAWINGS

FIG. 1 is a schematic diagram illustrating the configuration of a biological data monitoring system in a first embodiment of the present invention.

FIG. 2 is a block diagram illustrating the configuration of a wireless sensing terminal in a first embodiment of the present invention.

FIG. 3 is a block diagram illustrating the configuration of a data collection terminal in a first embodiment of the present invention.

FIG. 4 is a flowchart illustrating an operation procedure of a wireless sensing terminal in a first embodiment of the present invention.

FIG. 5 is a flowchart illustrating a process of deciding an operation cycle of an activation signal reception circuit in a first embodiment of the present invention.

FIG. 6 is a flowchart illustrating an operation procedure of a data collection terminal in a first embodiment of the present invention.

FIGS. 7A and 7B are a timing chart illustrating a relation between a cycle of a second standby state and a second activation state when an operation cycle of an activation signal reception circuit is a short cycle and a cycle of a standby state and a transmission state of an activation signal transmission circuit in a first embodiment of the present invention.

FIGS. 8A and 8B are a timing chart illustrating a relation between a cycle of a second standby state and a second activation state when an operation cycle of an activation signal reception circuit is a long cycle and a cycle of a standby state and a transmission state of an activation signal transmission circuit in a first embodiment of the present invention.

FIG. 9 is a block diagram illustrating the configuration of a wireless sensing terminal in a second embodiment of the present invention.

FIG. 10 is a flowchart illustrating an operation procedure of a wireless sensing terminal in a second embodiment of the present invention.

FIG. 11 is a flowchart illustrating a process of deciding an operation cycle of an activation signal reception circuit in a second embodiment of the present invention.

FIG. 12 is a block diagram illustrating the configuration of a wireless sensing terminal in a third embodiment of the present invention.

FIG. 13 is a flowchart illustrating an operation procedure of a wireless sensing terminal in a third embodiment of the present invention.

FIG. 14 is a flowchart illustrating a process of deciding an operation cycle of an activation signal reception circuit in a third embodiment of the present invention.

FIG. 15 is a block diagram illustrating the configuration of a wireless sensing terminal in a fourth embodiment of the present invention.

FIG. 16 is a block diagram illustrating the configuration of a data collection terminal in a fourth embodiment of the present invention.

FIG. 17 is a flowchart illustrating an operation procedure of a wireless sensing terminal in a fourth embodiment of the present invention.

FIG. 18 is a flowchart illustrating an operation procedure of a data collection terminal in a fourth embodiment of the present invention.

FIG. 19 is a block diagram illustrating the configuration of a wireless sensing terminal in a fifth embodiment of the present invention.

FIG. 20 is a block diagram illustrating the configuration of a data collection terminal in a fifth embodiment of the present invention.

FIG. 21 is a flowchart illustrating an operation procedure of a wireless sensing terminal in a fifth embodiment of the present invention.

FIG. 22 is a flowchart illustrating an operation procedure of a data collection terminal in a fifth embodiment of the present invention.

FIGS. 23A and 23B are a timing chart illustrating a relation between a cycle of a second standby state and a second activation state when an operation cycle of an activation signal reception circuit is a long cycle and a cycle of a standby state and a transmission state when an operation cycle of an activation signal transmission circuit is a long cycle in a fifth embodiment of the present invention.

### DETAILED DESCRIPTION OF THE INVENTION

### First Embodiment

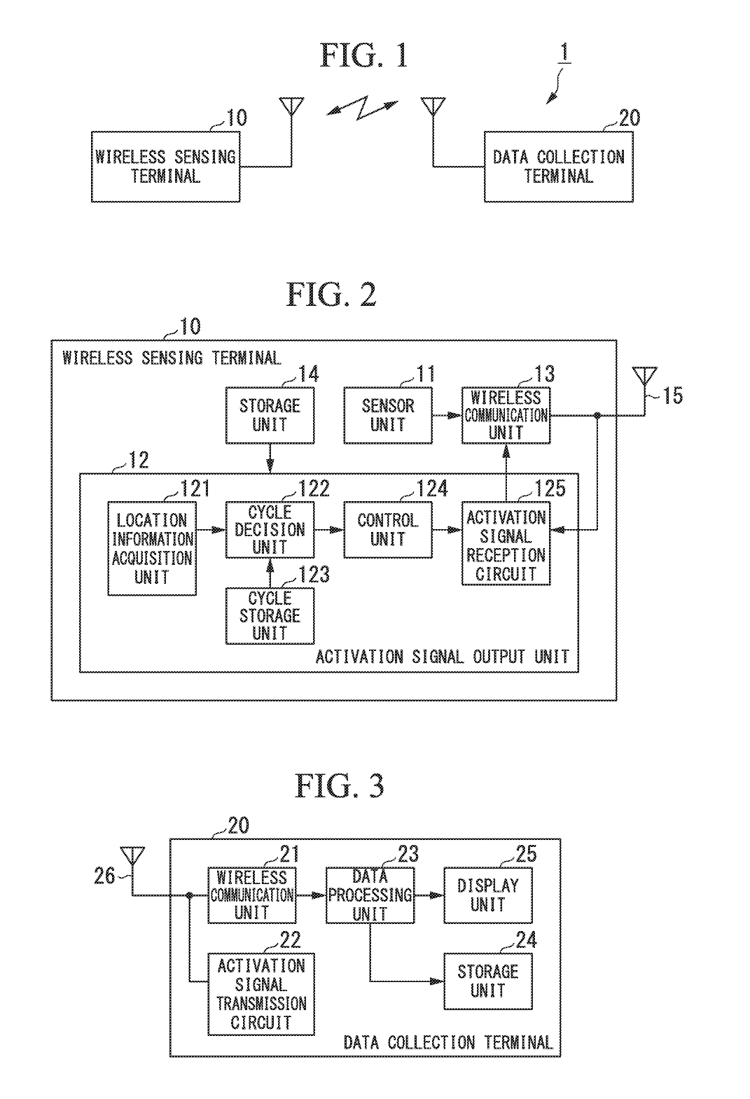

Hereinafter, a first embodiment of the present invention will be described with reference to the accompanying drawings. FIG. 1 is a schematic diagram illustrating the configuration of a biological data monitoring system in the present embodiment. In the example illustrated in FIG. 1, a biological data monitoring system 1 includes a wireless sensing terminal 10 and a data collection terminal 20. The wireless sensing terminal 10 acquires biological data such as blood pressure, pulse, electrocardiograph, heartbeat, blood oxygen level, body temperature, glycosuria, or blood sugar, from the surface of the human body or the inside of the body using various sensors. Furthermore, the wireless sensing terminal 10 acquires device status data, which indicates the status of each element provided in the wireless sensing terminal 10, using various sensors. Furthermore, the wireless sensing terminal 10 wirelessly transmits the acquired biological data and device status data to the data collection terminal 20. The data collection terminal 20 collects and stores the biological data and the device status data wirelessly transmitted from the wireless sensing terminal 10. The wireless sensing terminal 10 is installed on the surface of the human body or in the inside of the body. Furthermore, the data collection terminal 20 is installed outside of the body.

In the present embodiment, a description will be given on the assumption that the wireless sensing terminal 10 and the data collection terminal 20 wirelessly communicate with each other in a one-to-one manner. However, the present invention is applicable to relations of 1 to N, M to 1, and M to N (N and M are natural numbers).

Next, the configuration of the wireless sensing terminal 10 will be described. FIG. 2 is a block diagram illustrating the configuration of the wireless sensing terminal 10 in the present embodiment. In the example illustrated in FIG. 2, the wireless sensing terminal 10 includes a sensor unit 11, an activation signal output unit 12, a wireless communication unit 13 (a communication module or a first communication module), a storage unit 14, and an antenna 15. The wireless sensing terminal 10 includes a battery (not illustrated). The battery supplies power to each element provided in the wireless sensing terminal 10.

The sensor unit 11 is installed on the surface of the human body or in the inside of the body to acquire the biological data by sensing blood pressure, pulse, electrocardiograph, heartbeat, blood oxygen level, body temperature, glycosuria, or blood sugar. Furthermore, the sensor unit 11 acquires the device status data by sensing the status of each element provided in the wireless sensing terminal 10. Hereinafter, the biological data and the device status data acquired by the sensor unit 11 will be referred to as collection data. Furthermore, the sensor unit 11 outputs the collection data to the wireless communication unit 13.

The activation signal output unit 12 includes a location information acquisition unit 121 (an acquisition unit), a cycle decision unit 122, a cycle storage unit 123, a control unit 124, and an activation signal reception circuit 125 (an activation signal generation unit or a first activation signal generation unit). The location information acquisition unit 121 acquires location information of its own terminal using GPS (Global Positioning System) and the like, and outputs location information, which indicates whether a current position of its own terminal is within a predetermined location range (an area or a region), to the cycle decision unit 122. The predetermined location range may be decided in advance or arbitrarily set. For example, an inside of a hospital or a house, where the wireless sensing terminal 10 performs a transmission operation of the collection data, is set as the predetermined location range.

The cycle decision unit 122 decides an operation cycle of the activation signal reception circuit 125 based on the location information input from the location information acquisition unit 121, and an operation cycle table stored in the cycle storage unit 123. The cycle storage unit 123 stores the operation cycle table indicating the operation cycle of the activation signal reception circuit 125 corresponding to the location information. Values of the operation cycle table may be decided in advance or arbitrarily set.

The operation cycle table of the present embodiment stores an operation cycle of m seconds as the operation cycle of the activation signal reception circuit 125 corresponding to the location information indicating that the current position of its own device is within the predetermined location range, and stores an operation cycle of n seconds as the operation cycle of the activation signal reception circuit 125 corresponding to the location information indicating that the current position of its own device is outside of the predetermined location range. In this case, when the location information input from the location information acquisition unit 121 indicates that the current position of its own device is within the predetermined location range, the cycle decision unit 122 decides the operation cycle of the activation signal reception circuit 125 as m seconds. Furthermore, when the location information input from the location information acquisition unit 121 indicates that the current position of its own device is outside of the predetermined location range, the cycle decision unit 122 decides the operation cycle of the activation signal reception circuit 125 as n seconds. The operation cycle of n seconds is longer than the operation cycle of m seconds. That is, when the current position of its own device is within the predetermined location range, the cycle decision unit 122 decides the operation cycle as a short cycle. Furthermore, when the current position of its own device is outside of the predetermined location range, the cycle decision unit 122 decides the operation cycle as a long cycle.

Based on the operation cycle decided by the cycle decision unit 122, the control unit 124 outputs a reception instruction signal to the activation signal reception circuit 125 and allows the activation signal reception circuit 125 to perform a reception process. When the reception instruction signal is input from the control unit 124, the activation signal reception circuit 125 performs a reception operation for a given time. Then, the activation signal reception circuit 125 ends the reception operation and operates in a standby state (a second standby state). In this way, the activation signal reception circuit 125 is possible to repeat an operation in a state (a second activation state) of performing the reception operation and an operation in the second standby state at a constant cycle. Since the activation signal reception circuit 125 performs the reception operation when operating in the second activation state, power consumption of the activation signal reception circuit 125 is high when operating in the second activation state as compared with the case of operating in the second standby state. Furthermore, when the activation signal transmitted from the data collection terminal 20 is received during the reception operation, the activation signal reception circuit 125 outputs a shift signal to the wireless communication unit 13.

When the shift signal is input from the activation signal reception circuit 125, the wireless communication unit 13 transmits the collection data, which is input from the sensor unit 11, to the data collection terminal 20 through the antenna 15. After the transmission of the collection data is completed, the wireless communication unit 13 operates in a standby state (a first standby state). In this way, the wireless communication unit 13 is possible to operate in one of a state (a first activation state) of performing the transmission operation and the first standby state. Since the wireless communication unit 13 performs the transmission operation in the first activation state, power consumption of the wireless communication unit 13 is high when operating in the first activation state as compared with the case of operating in the first standby state. The storage unit 14 stores a program executed by each element provided in the wireless sensing terminal 10, or data used in an operation thereof. The essential configuration representing the characteristic of the present invention is the wireless communication unit 13, the cycle decision unit 122, and the activation signal reception circuit 125.

Next, the configuration of the data collection terminal 20 will be described. FIG. 3 is a block diagram illustrating the configuration of the data collection terminal 20 in the present embodiment. In the example illustrated in FIG. 3, the data collection terminal 20 includes a wireless communication unit 21 (a second communication module), an activation signal transmission circuit 22 (a second activation signal generation unit), a data processing unit 23, a storage unit 24, a display unit 25, and an antenna 26. The data collection terminal 20 includes a battery (not illustrated). The battery supplies power to each element provided in the data collection terminal 20.

The wireless communication unit 21 receives the collection data, which is transmitted from the wireless sensing terminal 10, through the antenna 26. The activation signal transmission circuit 22 operates in one of a standby state and a transmission state in which power consumption is higher than that in the standby state. The activation signal transmission circuit 22 performs no process when operating in the standby state. In the case of operating in the transmission state, when an instruction input for receiving the collection data has been accepted, the activation signal transmission circuit 22 transmits an activation signal to the wireless sensing terminal 10 through the antenna 26. For example, when a transmission request button (not illustrated) provided in the data collection terminal 20 is pressed by a user, the activation signal transmission circuit 22 determines that the instruction input for receiving the collection data has been accepted. The activation signal transmission circuit 22 repeats an operation in the standby state and an operation in the transmission state at a constant cycle.

The data processing unit 23 converts a data format of the collection data received in the wireless communication unit 21 into a data format for storage, generates data for storage, and outputs the generated data for storage to the storage unit 24. Furthermore, the data processing unit 23 converts the collection data received in the wireless communication unit 21 into display data such as text or an image, and outputs the converted display data to the display unit 25. The storage unit 24 stores the data for storage input from the data processing unit 23. Furthermore, the storage unit 24 stores a program executed by each element provided in the data collection terminal 20, or data used in an operation thereof. The display unit 25 displays the display data input from the data processing unit 23. By this configuration, the data collection terminal 20 is possible to allow the collection data transmitted from the wireless sensing terminal 10 to be displayed on the display unit 25, and to be stored in the storage unit 24.

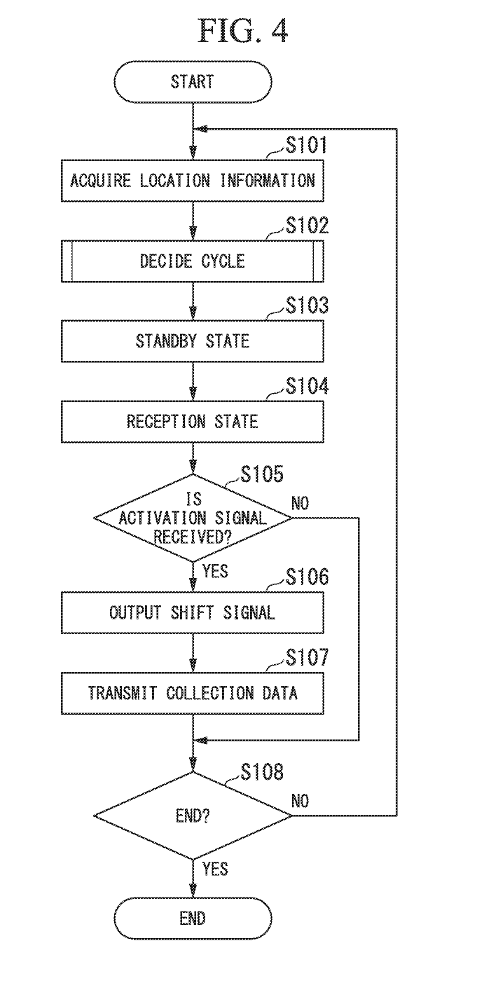

Next, an operation procedure of the wireless sensing terminal 10 will be described. FIG. 4 is a flowchart illustrating an operation procedure of the wireless sensing terminal 10 in the present embodiment.

(Step S101) The location information acquisition unit 121 acquires the location information of its own terminal, and outputs the location information, which indicates whether the current position of its own terminal is within the predetermined location range, to the cycle decision unit 122. Then, the procedure proceeds to a process of step S102.

(Step S102) The cycle decision unit 122 decides the operation cycle of the activation signal reception circuit 125 based on the location information input from the location information acquisition unit 121 in the process of step S101, and the operation cycle table stored in the cycle storage unit 123. Then, the procedure proceeds to a process of step S103. Details of the process of deciding the operation cycle of the activation signal reception circuit 125 will be described later.

(Step S103) The control unit 124 controls the activation signal reception circuit 125 to operate in the second standby state based on the operation cycle decided by the cycle decision unit 122 in the process of step S102. In detail, the control unit 124 waits for a process for the operation cycle decided by the cycle decision unit 122. Since the reception instruction signal is not input from the control unit 124, the activation signal reception circuit 125 operates in the second standby state. Then, the procedure proceeds to a process of step S104.

(Step S104) Based on the operation cycle decided by the cycle decision unit 122 in the process of step S102, the control unit 124 outputs a reception instruction signal to the activation signal reception circuit 125 and allows the activation signal reception circuit 125 to perform a reception process. Since the reception instruction signal is input from the control unit 124, the activation signal reception circuit 125 operates in the second activation state. That is, the activation signal reception circuit 125 performs a reception operation. Then, the procedure proceeds to a process of step S105.

(Step S105) The activation signal reception circuit 125 determines whether an activation signal has been received during the reception operation. When it is determined that the activation signal has been received during the reception operation, the procedure proceeds to a process of step S106. In other cases, the procedure proceeds to a process of step S108.

(Step S106) The activation signal reception circuit 125 outputs a shift signal to the wireless communication unit 13. Then, the procedure proceeds to a process of step S107.

(Step S107) Since the shift signal is input in the process of step S106, the wireless communication unit 13 transmits the collection data, which has been input from the sensor unit 11, to the data collection terminal 20 through the antenna 15 (operates in the first activation state). Furthermore, after the transmission of the collection data is completed, the wireless communication unit 13 operates in the first standby state. Then, the procedure proceeds to a process of step S108.

(Step S108) The control unit 124 determines whether to end the procedure. For example, when the wireless communication unit 13 receives an end command from the data collection terminal 20, the control unit 124 determines to end the procedure. When the control unit 124 determines to end the procedure, the procedure is ended. In other cases, the procedure returns to the process of step S101.

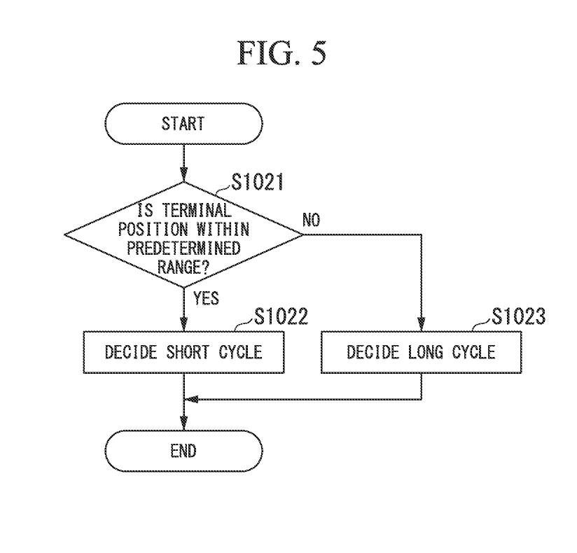

Next, details of the process of deciding the operation cycle of the activation signal reception circuit 125 in the process of step S102 will be described. FIG. 5 is a flowchart illustrating the process of deciding the operation cycle of the activation signal reception circuit 125.

(Step S1021) The cycle decision unit 122 determines whether the current position of its own device is within a predetermined location range based on the location information input from the location information acquisition unit 121, and the operation cycle table stored in the cycle storage unit 123. When the cycle decision unit 122 determines that the current position of its own device is within the predetermined location range, the procedure proceeds to a process of step S1022. In other cases, the procedure proceeds to a process of step S1023.

(Step S1022) The cycle decision unit 122 decides the operation cycle of the activation signal reception circuit 125 as a short cycle. Then, the procedure ends.

(Step S1023) The cycle decision unit 122 decides the operation cycle of the activation signal reception circuit 125 as a long cycle. Then, the procedure ends.

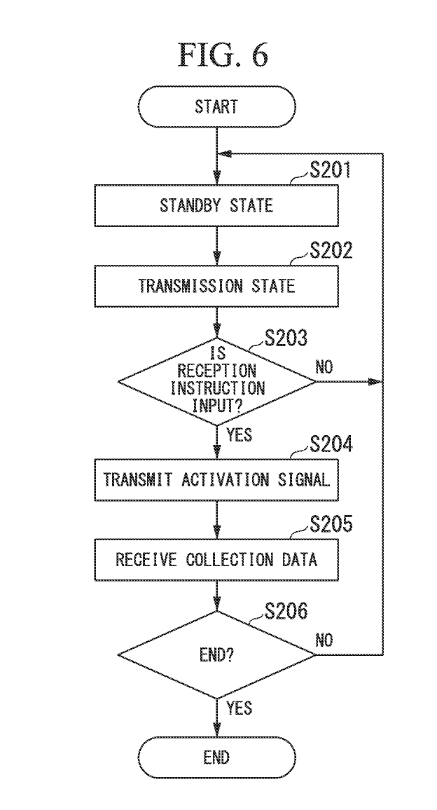

Next, the operation procedure of the data collection terminal 20 will be described. FIG. 6 is a flowchart illustrating the operation procedure of the data collection terminal 20 in the present embodiment.

(Step S201) The activation signal transmission circuit 22 operates in the standby state for a constant time. Then, the procedure proceeds to a process of step S202.

(Step S202) The activation signal transmission circuit 22 operates in the transmission state for a constant time. Then, the procedure proceeds to a process of step S203.

(Step S203) The activation signal transmission circuit 22 determines whether instruction input for receiving the collection data has been accepted. When the activation signal transmission circuit 22 determines that the instruction input for receiving the collection data has been accepted, the procedure proceeds to a process of step S204. In other cases, the procedure returns to the process of step S201.

(Step S204) The activation signal transmission circuit 22 transmits an activation signal to the wireless sensing terminal 10 through the antenna 26. Then, the procedure proceeds to a process of step S205.

(Step S205) The wireless communication unit 21 receives the collection data, which is transmitted from the wireless sensing terminal 10, through the antenna 26. Furthermore, the data processing unit 23 converts a data format of the collection data received in the wireless communication unit 21 into a data format for storage, generates data for storage, and outputs the generated data for storage to the storage unit 24. Furthermore, the data processing unit 23 converts the collection data received in the wireless communication unit 21 into display data such as text or an image, and outputs the converted display data to the display unit 25. The storage unit 24 stores the data for storage input from the data processing unit 23. The display unit 25 displays the display data input from the data processing unit 23. Then, the procedure proceeds to a process of step S206.

(Step S206) The activation signal transmission circuit 22 determines whether to end the procedure. For example, when a stop button (not illustrated) provided in the data collection terminal 20 is pressed by a user, the activation signal transmission circuit 22 determines to end the procedure. When the activation signal transmission circuit 22 determines to end the procedure, the procedure is ended. In other cases, the procedure returns to the process of step S201.

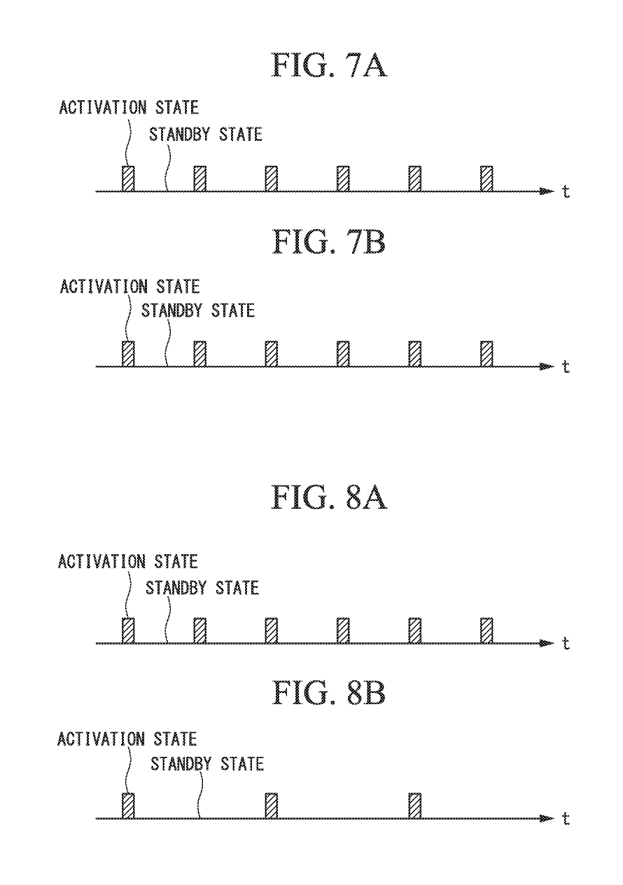

Next, a relation between a cycle of the second standby state and the second activation state of the activation signal reception circuit 125 provided in the wireless sensing terminal 10 and a cycle of the standby state and the transmission state of the activation signal transmission circuit 22 provided in the data collection terminal 20 will be described. FIGS. 7A and 7B are a timing chart illustrating a relation between a cycle of the second standby state and the second activation state when the operation cycle of the activation signal reception circuit 125 provided in the wireless sensing terminal 10 is a short cycle and a cycle of the standby state and the transmission state of the activation signal transmission circuit 22 provided in the data collection terminal 20 in the present embodiment. FIGS. 8A and 8B are a timing chart illustrating a relation between a cycle of the second standby state and the second activation state when the operation cycle of the activation signal reception circuit 125 provided in the wireless sensing terminal 10 is a long cycle and a cycle of the standby state and the transmission state of the activation signal transmission circuit 22 provided in the data collection terminal 20 in the present embodiment.

The activation signal reception circuit 125 provided in the wireless sensing terminal 10 repeats the operation in the second standby state and the operation in the second activation state in response to the cycle decided in the process of step S102. For example, when the cycle decision unit 122 decides the operation cycle of the activation signal reception circuit 125 as a short cycle, the control unit 124 controls the operation state of the activation signal reception circuit 125 provided in the wireless sensing terminal 10 such that the operation cycle of the activation signal reception circuit 125 is equal to the cycle of the standby state and the transmission state of the activation signal transmission circuit 22 provided in the data collection terminal 20, as illustrated in FIG. 7A. Furthermore, for example, when the cycle decision unit 122 decides the operation cycle of the activation signal reception circuit 125 as a long cycle, the control unit 124 controls the operation state of the activation signal reception circuit 125 provided in the wireless sensing terminal 10 such that the operation cycle of the activation signal reception circuit 125 is an integer times the cycle of the standby state and the transmission state of the activation signal transmission circuit 22 provided in the data collection terminal 20, as illustrated in FIG. 8. In the example illustrated in FIG. 8, the control unit 124 controls the operation state of the activation signal reception circuit 125 provided in the wireless sensing terminal 10 such that the operation cycle of the activation signal reception circuit 125 is twice as long as the cycle of the standby state and the transmission state of the activation signal transmission circuit 22 provided in the data collection terminal 20.

In the example illustrated in FIG. 7B, when the cycle decision unit 122 decides the operation cycle of the activation signal reception circuit 125 as a short cycle, the control unit 124 controls the operation state of the activation signal reception circuit 125 provided in the wireless sensing terminal 10 such that the operation cycle of the activation signal reception circuit 125 is equal to the cycle of the standby state and the transmission state of the activation signal transmission circuit 22 provided in the data collection terminal 20. However, the present invention is not limited thereto. The control unit 124 may control the operation state of the activation signal reception circuit 125 such that the operation cycle of the activation signal reception circuit 125 is an integer times the cycle of the standby state and the transmission state of the activation signal transmission circuit 22. Similarly, in the example illustrated in FIG. 8, when the cycle decision unit 122 decides the operation cycle of the activation signal reception circuit 125 as a long cycle, the control unit 124 controls the operation state of the activation signal reception circuit 125 provided in the wireless sensing terminal 10 such that the operation cycle of the activation signal reception circuit 125 is twice as long as the cycle of the standby state and the transmission state of the activation signal transmission circuit 22 provided in the data collection terminal 20. However, the present invention is not limited thereto. The control unit 124 may control the operation state of the activation signal reception circuit 125 such that the operation cycle of the activation signal reception circuit 125 is an integer times the cycle of the standby state and the transmission state of the activation signal transmission circuit 22.

As described above, according to the present embodiment, the wireless communication unit 13 provided in the wireless sensing terminal 10 operates in one of the first standby state of performing no transmission operation, and the first activation state of transmitting the collection data to the data collection terminal 20 different from its own terminal. Furthermore, after the transmission of the collection data is completed, the wireless communication unit 13 operates in the first standby state. Furthermore, the activation signal reception circuit 125 operates in one of the second standby state of performing no reception operation, and the second activation state of performing the reception operation, and repeats the operation in the second activation state and the operation in the second standby state at a predetermined time interval. Furthermore, in the case in which an activation signal is received from the data collection terminal 20 when operating in the second activation state, the activation signal reception circuit 125 outputs a shift signal for shifting the operation of the wireless communication unit 13 from the first standby state to the first activation state.

Furthermore, based on the location information indicating whether an estimation position of its own terminal is within the predetermined location range, the cycle decision unit 122 changes the predetermined time interval (a cycle) at which the activation signal reception circuit 125 repeats the operation in the second activation state and the operation in the second standby state. In detail, when the estimation position of its own terminal is within the predetermined location range, the cycle decision unit 122 shortens the predetermined time interval at which the activation signal reception circuit 125 repeats the operation in the second activation state and the operation in the second standby state (sets the cycle as a short cycle). Furthermore, when the estimation position of its own terminal is outside of the predetermined location range, the cycle decision unit 122 lengthens the predetermined time interval at which the activation signal reception circuit 125 repeats the operation in the second activation state and the operation in the second standby state (sets the cycle as a long cycle).

In this way, when the wireless sensing terminal 10 is in the predetermined location range, it is possible to shorten the cycle in which the activation signal reception circuit 125 operates in the second activation state. Furthermore, when the wireless sensing terminal 10 is not in the predetermined location range, it is possible to lengthen the cycle in which the activation signal reception circuit 125 operates in the second activation state. Furthermore, when the activation signal reception circuit 125 receives an activation signal from the data collection terminal 20, the wireless communication unit 13 performs transmission of the collection data. When the transmission of the collection data has been completed, the wireless communication unit 13 operates in the first standby state.

Consequently, when the position of its own terminal is outside of the predetermined location range, the wireless sensing terminal 10 is possible to lengthen a time for which the activation signal reception circuit 125 operates in the second standby state. Thus, the wireless sensing terminal 10 is possible to reduce power consumption. For example, when the predetermined location range is set as a hospital or a house, since it is estimated that its own terminal is in a place other than a place at which a transmission operation of collection data obtained in the hospital or the house is performed, it is possible to further reduce power consumption.

In the aforementioned example, in response to the case in which its own terminal is in the predetermined location range and the case in which the wireless sensing terminal 10 is not in the predetermined location range, the cycles in which the activation signal reception circuit 125 operates in the second activation state and the second standby state are decided. However, the present invention is not limited thereto. For example, a plurality of ranges may be set, and it may be possible to decide the cycles in which the activation signal reception circuit 125 operates in the second activation state and the second standby state in response to the case in which its own terminal is in each range.

### Second Embodiment

Next, a second embodiment of the present invention will be described with reference to the accompanying drawings. A biological monitoring system in the present embodiment includes a wireless sensing terminal 30 and a data collection terminal 20, similarly to the first embodiment. A difference between the present embodiment and the first embodiment is a configuration of an activation signal output unit provided in the wireless sensing terminal 30. Other configurations provided in the wireless sensing terminal 30 in the present embodiment are the same as those of the first embodiment. Furthermore, the data collection terminal 20 in the present embodiment has the same configuration as the data collection terminal 20 in the first embodiment. Furthermore, the operation of the data collection terminal 20 in the present embodiment is the same as that of the data collection terminal 20 in the first embodiment.

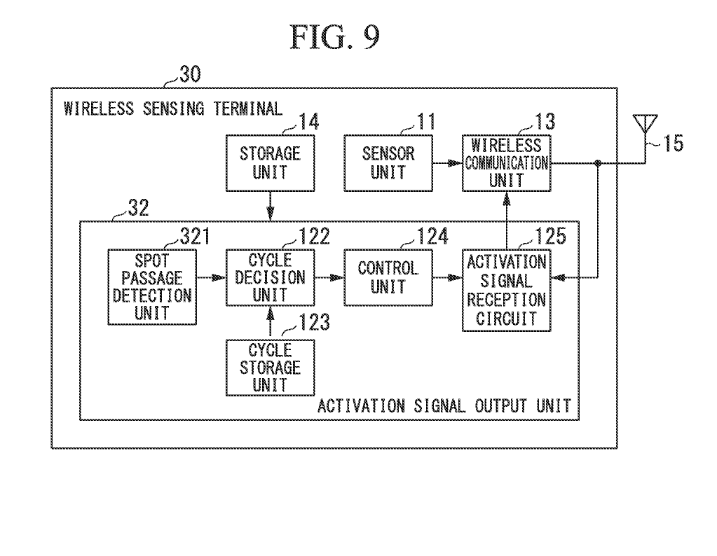

Next, the configuration of the wireless sensing terminal 30 will be described. FIG. 9 is a block diagram illustrating the configuration of the wireless sensing terminal 30 in the present embodiment. In the example illustrated in FIG. 9, the wireless sensing terminal 30 includes a sensor unit 11, an activation signal output unit 32, a wireless communication unit 13, a storage unit 14, and an antenna 15. The wireless sensing terminal 30 includes a battery (not illustrated). The battery supplies power to each element provided in the wireless sensing terminal 30.

The sensor unit 11, the wireless communication unit 13, the storage unit 14, and the antenna 15 are the same as those of the first embodiment. The activation signal output unit 32 includes a spot passage detection unit 321 (an acquisition unit), a cycle decision unit 122, a cycle storage unit 123, a control unit 124, and an activation signal reception circuit 125. The control unit 124 and the activation signal reception circuit 125 are the same as those of the first embodiment.

The spot passage detection unit 321 detects that its own terminal has passed through a predetermined spot (a place) using RFID (Radio Frequency IDentification) and the like, and outputs spot passage time information, which indicates a time at which the wireless sensing terminal 30 has passed through the predetermined spot, to the cycle decision unit 122. The predetermined spot may be decided in advance or arbitrarily set. For example, an entrance of a hospital or a house in which the wireless sensing terminal 30 performs a transmission operation of collection data is set as the predetermined spot.

The cycle decision unit 122 decides an operation cycle of the activation signal reception circuit 125 based on the spot passage time information input from the spot passage detection unit 321, a current time, and an operation cycle table stored in the cycle storage unit 123. The cycle storage unit 123 stores the operation cycle table indicating the operation cycle of the activation signal reception circuit 125 corresponding to a lapse time from the spot passage time indicated by the spot passage time information. The cycle decision unit 122 acquires a current time from a clock (not illustrated) provided in the wireless sensing terminal 30. Furthermore, values of the operation cycle table may be decided in advance or arbitrarily set.

The operation cycle table of the present embodiment stores an operation cycle of m seconds as the operation cycle of the activation signal reception circuit 125 corresponding to the case in which the lapse time from the spot passage time indicated by the spot passage time information is within x minutes (within a predetermined time), and stores an operation cycle of n seconds as the operation cycle of the activation signal reception circuit 125 corresponding to the case in which the lapse time from the spot passage time indicated by the spot passage time information exceeds x minutes (exceeds the predetermined time). In this case, when the lapse time from the spot passage time indicated by the spot passage time information is within x minutes, the cycle decision unit 122 decides the operation cycle of the activation signal reception circuit 125 as m seconds (a short cycle). Furthermore, when the lapse time from the spot passage time indicated by the spot passage time information exceeds x minutes, the cycle decision unit 122 decides the operation cycle of the activation signal reception circuit 125 as n seconds (a long cycle). The operation cycle of n seconds is longer than the operation cycle of m seconds.

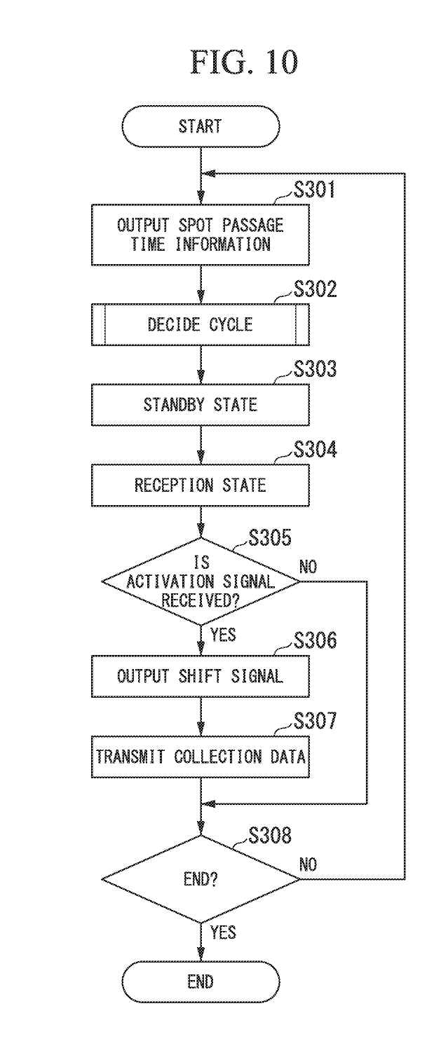

Next, an operation procedure of the wireless sensing terminal 30 will be described. FIG. 10 is a flowchart illustrating an operation procedure of the wireless sensing terminal 30 in the present embodiment.

(Step S301) The spot passage detection unit 321 detects that its own terminal has passed through the predetermined spot using RFID and the like, and outputs the spot passage time information, which indicates the time at which the wireless sensing terminal 30 has passed through the predetermined spot, to the cycle decision unit 122. Then, the procedure proceeds to a process of step S302.

(Step S302) The cycle decision unit 122 decides the operation cycle of the activation signal reception circuit 125 based on the spot passage time information input from the spot passage detection unit 321 in the process of step S301, the current time, and the operation cycle table stored in the cycle storage unit 123. Then, the procedure proceeds to a process of step S303. Details of the process of deciding the operation cycle of the activation signal reception circuit 125 will be described later.

Processes of step S303 to step 308 are the same as the processes of step S103 to step S108 in the first embodiment.

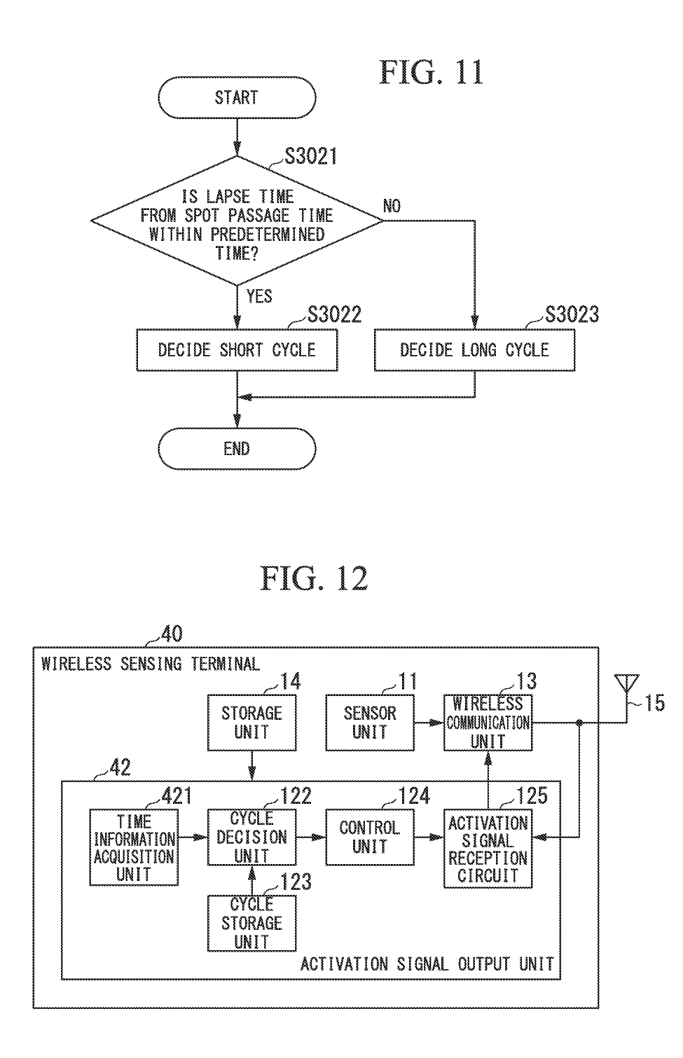

Next, details of the process of deciding the operation cycle of the activation signal reception circuit 125 in the process of step S302 will be described. FIG. 11 is a flowchart illustrating the process of deciding the operation cycle of the activation signal reception circuit 125.

(Step S3021) The cycle decision unit 122 determines whether the lapse time from the spot passage time indicated by the spot passage time information input from the spot passage detection unit 321 is within the predetermined time. When the cycle decision unit 122 determines that the lapse time from the spot passage time is within the predetermined time, the procedure proceeds to a process of step S3022. In other cases, the procedure proceeds to a process of step S3023.

(Step S3022) The cycle decision unit 122 decides the operation cycle of the activation signal reception circuit 125 as a short cycle. Then, the procedure ends.

(Step S3023) The cycle decision unit 122 decides the operation cycle of the activation signal reception circuit 125 as a long cycle. Then, the procedure ends.

As described above, according to the present embodiment, when a time after passing through the predetermined spot is within x minutes, the cycle decision unit 122 provided in the wireless sensing terminal 30 decides the operation cycle as a short cycle. Furthermore, when the time after passing through the predetermined spot exceeds x minutes, the cycle decision unit 122 decides the operation cycle as a long cycle. For example, in the case in which the predetermined spot is an entrance of a hospital, when a time after passing through the entrance of the hospital is within x minutes, that is, when it is highly probable that the wireless sensing terminal 30 is in the hospital, the cycle decision unit 122 decides the operation cycle as a short cycle (decides the cycle as a short cycle). Furthermore, when the time after passing through the entrance of the hospital exceeds x minutes, that is, when it is less probable that the wireless sensing terminal 30 is in the hospital, the cycle decision unit 122 decides the operation cycle as a long cycle (decides the cycle as a long cycle).

Consequently, when the time after passing through the predetermined spot exceeds a predetermined time, that is, when it is highly probable that the position of the wireless sensing terminal 30 is not in a predetermined location range, the wireless sensing terminal 30 is possible to lengthen a time for which the activation signal reception circuit 125 operates in the second standby state. Thus, the wireless sensing terminal 30 is possible to further reduce power consumption. For example, in the case in which the predetermined spot is set as an entrance of a hospital or an entrance of a house, when it is possible to estimate that its own terminal is in a place other than a place at which a transmission operation of the collection data obtained in the hospital or the house is performed, the wireless sensing terminal 30 is possible to further reduce power consumption.

### Third Embodiment

Next, a third embodiment of the present invention will be described with reference to the accompanying drawings. A biological monitoring system in the present embodiment includes a wireless sensing terminal 40 and a data collection terminal 20, similarly to the first embodiment. A difference between the present embodiment and the first embodiment is a configuration of an activation signal output unit provided in the wireless sensing terminal 40. Other configurations provided in the wireless sensing terminal 40 in the present embodiment are the same as those of the first embodiment. Furthermore, the data collection terminal 20 in the present embodiment has the same configuration as the data collection terminal 20 in the first embodiment. Furthermore, the operation of the data collection terminal 20 in the present embodiment is the same as that of the data collection terminal 20 in the first embodiment.

Next, the configuration of the wireless sensing terminal 40 will be described. FIG. 12 is a block diagram illustrating the configuration of the wireless sensing terminal 40 in the present embodiment. In the example illustrated in FIG. 12, the wireless sensing terminal 40 includes a sensor unit 11, an activation signal output unit 42, a wireless communication unit 13, a storage unit 14, and an antenna 15. The wireless sensing terminal 40 includes a battery (not illustrated). The battery supplies power to each element provided in the wireless sensing terminal 40.

The sensor unit 11, the wireless communication unit 13, the storage unit 14, and the antenna 15 are the same as those of the first embodiment. The activation signal output unit 42 includes a time information acquisition unit 421, a cycle decision unit 122, a cycle storage unit 123, a control unit 124, and an activation signal reception circuit 125. The control unit 124 and the activation signal reception circuit 125 are the same as those of the first embodiment.

The time information acquisition unit 421 acquires a current time using an RTC (Real Time Clock) and the like, and outputs time information indicating the current time to the cycle decision unit 122. The cycle decision unit 122 decides an operation cycle of the activation signal reception circuit 125 based on the time information input from the time information acquisition unit 421 and an operation cycle table stored in the cycle storage unit 123. The cycle storage unit 123 stores the operation cycle table indicating the operation cycle of the activation signal reception circuit 125 corresponding to the current time indicated by the time information. Values of the operation cycle table may be decided in advance or arbitrarily set.

The operation cycle table of the present embodiment stores an operation cycle of m seconds as the operation cycle of the activation signal reception circuit 125 corresponding to the case in which the current time indicated by the time information is from a o'clock to b o'clock (within a predetermined time). Furthermore, the operation cycle table stores an operation cycle of n seconds as the operation cycle of the activation signal reception circuit 125 corresponding to the case in which the current time indicated by the time information is not from a o'clock to b o'clock (outside of the predetermined time). In this case, when the current time indicated by the time information is from a o'clock to b o'clock (within the predetermined time), the cycle decision unit 122 decides the operation cycle of the activation signal reception circuit 125 as m seconds (a short cycle). Furthermore, in this case, when the current time indicated by the time information is not from a o'clock to b o'clock (outside of the predetermined time), the cycle decision unit 122 decides the operation cycle of the activation signal reception circuit 125 as n seconds (a long cycle). The operation cycle of n seconds is longer than the operation cycle of m seconds.

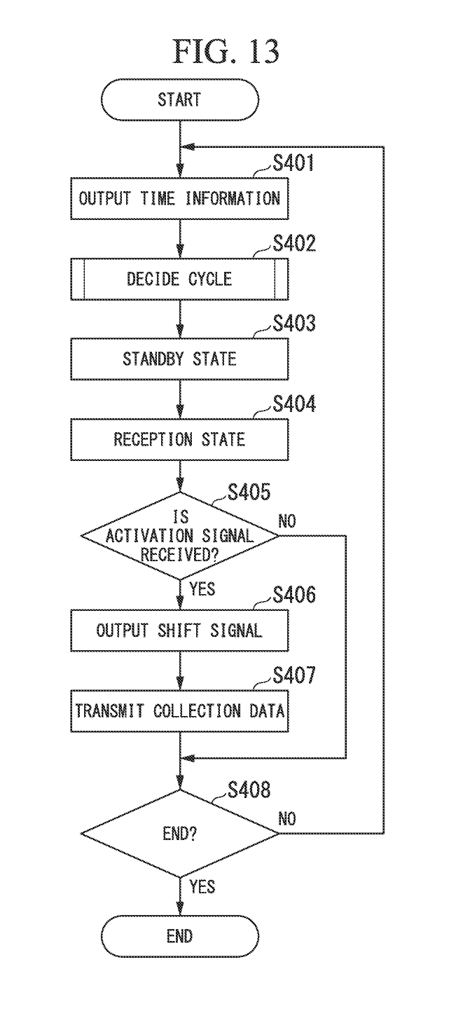

Next, an operation procedure of the wireless sensing terminal 40 will be described. FIG. 13 is a flowchart illustrating an operation procedure of the wireless sensing terminal 40 in the present embodiment.

(Step S401) The time information acquisition unit 421 acquires the current time using an RTC and the like, and outputs the time information indicating the current time to the cycle decision unit 122. Then, the procedure proceeds to a process of step S402.

(Step S402) The cycle decision unit 122 decides the operation cycle of the activation signal reception circuit 125 based on the time information input from the time information acquisition unit 421 in the process of step S401, and the operation cycle table stored in the cycle storage unit 123. Then, the procedure proceeds to a process of step S403. Details of the process of deciding the operation cycle of the activation signal reception circuit 125 will be described later.

Processes of step S403 to step 408 are the same as the processes of step S103 to step S108 in the first embodiment.

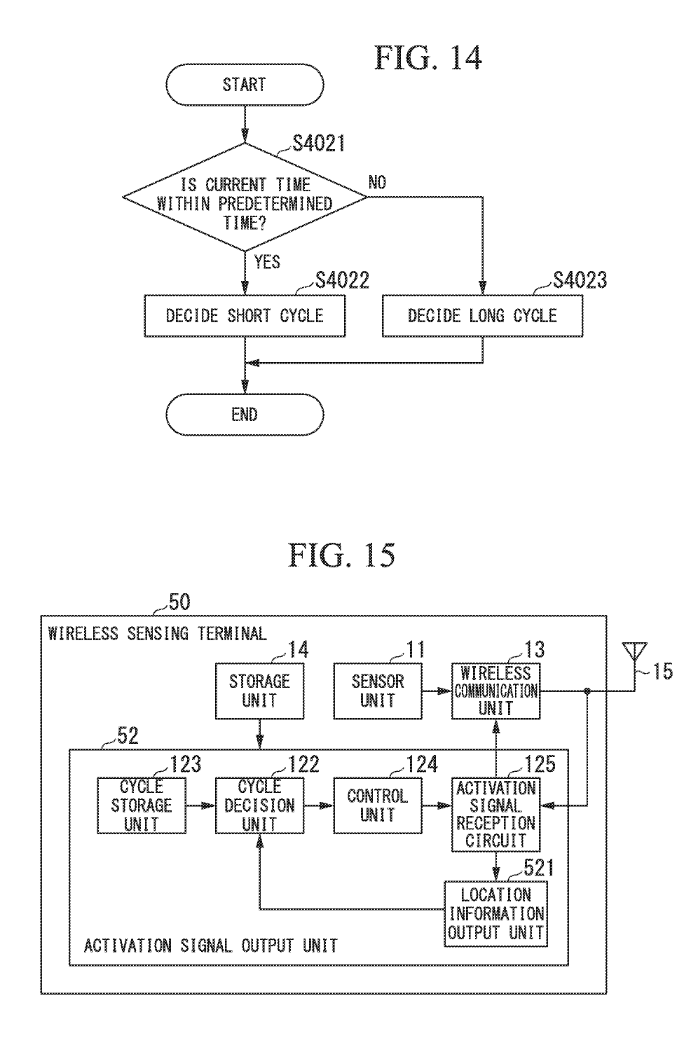

Next, details of the process of deciding the operation cycle of the activation signal reception circuit 125 in the process of step S402 will be described. FIG. 14 is a flowchart illustrating the process of deciding the operation cycle of the activation signal reception circuit 125.

(Step S4021) The cycle decision unit 122 determines whether the current time indicated by the time information input from the time information acquisition unit 421 is within the predetermined time. When the cycle decision unit 122 determines that the current time is within the predetermined time, the procedure proceeds to a process of step S4022. In other cases, the procedure proceeds to a process of step S4023.

(Step S4022) The cycle decision unit 122 decides the operation cycle of the activation signal reception circuit 125 as a short cycle. Then, the procedure ends.

(Step S4023) The cycle decision unit 122 decides the operation cycle of the activation signal reception circuit 125 as a long cycle. Then, the procedure ends.

As described above, according to the present embodiment, the cycle decision unit 122 provided in the wireless sensing terminal 40 decides the operation cycle as a short cycle when the current time is within the predetermined time, and decides the operation cycle as a long cycle when the current time is outside of the predetermined time. For example, in the case in which the predetermined time is set as bedtime, that is, when it is highly probable that the wireless sensing terminal 40 is in a bedroom of its own house, the cycle decision unit 122 decides the operation cycle as a short cycle (decides the cycle as a short cycle). Furthermore, when the current time is outside of the predetermined time, that is, when it is less probable that the wireless sensing terminal 40 is in the bedroom of its own house, the cycle decision unit 122 decides the operation cycle as a long cycle (decides the cycle as a long cycle).

Consequently, when the current time is outside of the predetermined time, that is, when it is highly probable that the position of the terminal is not in a predetermined location range, the wireless sensing terminal 40 is possible to lengthen a time for which the activation signal reception circuit 125 operates in the second standby state. Thus, the wireless sensing terminal 40 is possible to further reduce power consumption. For example, in the case in which the predetermined time is set as bedtime, when it is possible to estimate that its own terminal is in a place other than a place at which a transmission operation of collection data obtained in the bedroom of its own house is performed, the wireless sensing terminal 40 is possible to further reduce power consumption.

### Fourth Embodiment

Next, a fourth embodiment of the present invention will be described with reference to the accompanying drawings. A biological monitoring system in the present embodiment includes a wireless sensing terminal 50 and a data collection terminal 60, similarly to the first embodiment.

Next, the configuration of the wireless sensing terminal 50 will be described. FIG. 15 is a block diagram illustrating the configuration of the wireless sensing terminal 50 in the present embodiment. In the example illustrated in FIG. 15, the wireless sensing terminal 50 includes a sensor unit 11, an activation signal output unit 52, a wireless communication unit 13, a storage unit 14, and an antenna 15. The wireless sensing terminal 50 includes a battery (not illustrated). The battery supplies power to each element provided in the wireless sensing terminal 50.

The sensor unit 11, the wireless communication unit 13, the storage unit 14, and the antenna 15 are the same as those of the first embodiment. The activation signal output unit 52 includes a location information output unit 521, a cycle decision unit 122, a cycle storage unit 123, a control unit 124, and an activation signal reception circuit 125.

When a reception instruction signal is input from the control unit 124, the activation signal reception circuit 125 performs a reception operation for a given time, and then ends the reception operation and operates in the standby state (the second standby state). In this way, the activation signal reception circuit 125 is possible to repeat an operation in the state (the second activation state) of performing the reception operation and an operation in the second standby state at a constant cycle. Since the activation signal reception circuit 125 performs the reception operation when operating in the second activation state, power consumption of the activation signal reception circuit 125 is high when operating in the second activation state as compared with the case of operating in the second standby state. Furthermore, when data including a shift signal and a reception bit sequence, which is transmitted from the data collection terminal 60, is received during the reception operation, the activation signal reception circuit 125 outputs the shift signal to the wireless communication unit 13, and outputs the reception bit sequence to the location information output unit 521.

When location information is included in the reception bit sequence input from the activation signal reception circuit 125, the location information output unit 521 outputs the location information to the cycle decision unit 122. The location information transmitted from the data collection terminal 60 indicates whether an estimation position of the data collection terminal 60 is within a predetermined location range.

The cycle decision unit 122 decides an operation cycle of the activation signal reception circuit 125 based on the location information input from the location information output unit 521 and an operation cycle table stored in the cycle storage unit 123. The cycle storage unit 123 stores the operation cycle table indicating the operation cycle of the activation signal reception circuit 125 corresponding to the location information. Values of the operation cycle table may be decided in advance or arbitrarily set.

The operation cycle table of the present embodiment stores an operation cycle of m seconds as the operation cycle of the activation signal reception circuit 125 corresponding to location information indicating that a current position of the data collection terminal 60 is within the predetermined location range. Furthermore, in the case in which an operation cycle of n seconds is stored in advance as the operation cycle of the activation signal reception circuit 125 corresponding to location information indicating that the current position of the data collection terminal 60 is outside of the predetermined location range, when the location information input from the location information output unit 521 indicates that the current position of the data collection terminal 60 is within the predetermined location range, the cycle decision unit 122 decides the operation cycle of the activation signal reception circuit 125 as m seconds (a short cycle). Furthermore, when the location information input from the location information acquisition unit 121 indicates that the current position of the data collection terminal 60 is outside of the predetermined location range, the cycle decision unit 122 decides the operation cycle of the activation signal reception circuit 125 as n seconds (a long cycle). The operation cycle of n seconds is longer than the operation cycle of m seconds. That is, the cycle decision unit 122 decides the operation cycle as a short cycle when the current position of the data collection terminal 60 is within the predetermined location range, and decides the operation cycle as a long cycle when the current position of the data collection terminal 60 is outside of the predetermined location range.

Based on the operation cycle decided by the cycle decision unit 122, the control unit 124 outputs a reception instruction signal to the activation signal reception circuit 125 and allows the activation signal reception circuit 125 to perform a reception process.

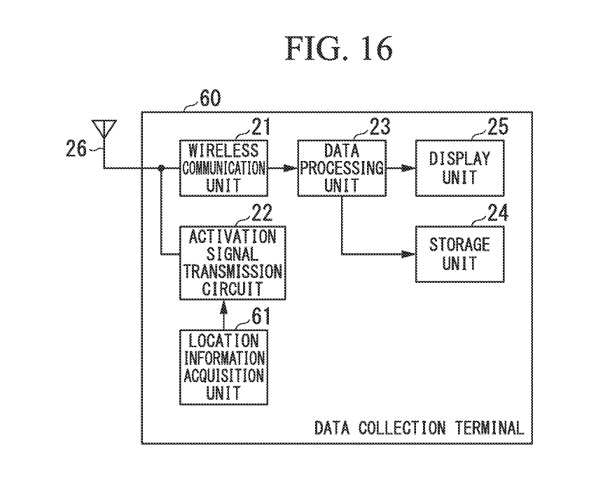

Next, the configuration of the data collection terminal 60 will be described. FIG. 16 is a block diagram illustrating the configuration of the data collection terminal 60 in the present embodiment. In the example illustrated in FIG. 16, the data collection terminal 60 includes a wireless communication unit 21, an activation signal transmission circuit 22, a data processing unit 23, a storage unit 24, a display unit 25, an antenna 26, and a location information acquisition unit 61 (an acquisition unit). The data collection terminal 60 includes a battery (not illustrated). The battery supplies power to each element provided in the data collection terminal 60.

The wireless communication unit 21, the data processing unit 23, the storage unit 24, the display unit 25, and the antenna 26 are the same as those of the first embodiment. The location information acquisition unit 61 acquires location information of its own terminal using GPS and the like, and outputs location information, which indicates whether a current position of its own terminal is within a predetermined location range, to the activation signal transmission circuit 22. The predetermined location range may be decided in advance or arbitrarily set. For example, an inside of a hospital or a house is set as the predetermined location range.

The activation signal transmission circuit 22 operates in one of a standby state and a transmission state in which power consumption is higher than that in the standby state. The activation signal transmission circuit 22 performs no process when operating in the standby state. In the case of operating in the transmission state, when instruction input for receiving collection data has been accepted, the activation signal transmission circuit 22 transmits the location information input from the location information acquisition unit 61, and an activation signal to the wireless sensing terminal 50 through the antenna 26. For example, when a transmission request button (not illustrated) provided in the data collection terminal 60 is pressed by a user, the activation signal transmission circuit 22 determines that the instruction input for receiving the collection data has been accepted. The activation signal transmission circuit 22 repeats an operation in the standby state and an operation in the transmission state at a constant cycle.

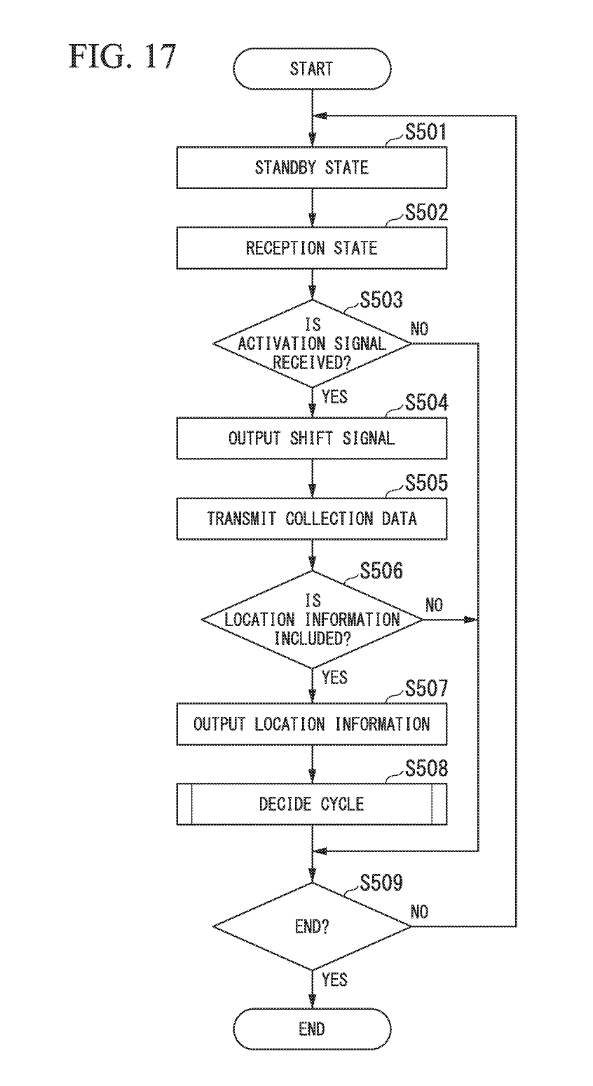

Next, an operation procedure of the wireless sensing terminal 50 will be described. FIG. 17 is a flowchart illustrating an operation procedure of the wireless sensing terminal 50 in the present embodiment.

(Step S501) The control unit 124 controls the activation signal reception circuit 125 to operate in the second standby state based on the operation cycle decided by the cycle decision unit 122. In detail, the control unit 124 waits for a process for the operation cycle decided by the cycle decision unit 122. Since a reception instruction signal is not input from the control unit 124, the activation signal reception circuit 125 operates in the second standby state. Then, the procedure proceeds to a process of step S502. At the activation of the wireless sensing terminal 50 (when a process of step S508 is not performed), the cycle decision unit 122 decides the operation cycle as a long cycle.

(Step S502) Based on the operation cycle decided by the cycle decision unit 122, the control unit 124 outputs the reception instruction signal to the activation signal reception circuit 125 and allows the activation signal reception circuit 125 to perform a reception process. Since the reception instruction signal is input from the control unit 124, the activation signal reception circuit 125 operates in the second activation state. That is, the activation signal reception circuit 125 performs a reception operation. Then, the procedure proceeds to a process of step S503.

(Step S503) The activation signal reception circuit 125 determines whether an activation signal has been received during the reception operation. When it is determined that the activation signal has been received during the reception operation, the procedure proceeds to a process of step S504. In other cases, the procedure proceeds to a process of step S509.

(Step S504) The activation signal reception circuit 125 outputs a shift signal to the wireless communication unit 13, and outputs a reception bit sequence to the location information output unit 521. Then, the procedure proceeds to a process of step S505.

(Step S505) Since the shift signal is input in the process of step S504, the wireless communication unit 13 transmits collection data, which has been input from the sensor unit 11, to the data collection terminal 60 through the antenna 15. Furthermore, after the transmission of the collection data is completed, the wireless communication unit 13 operates in the first standby state. Then, the procedure proceeds to a process of step S506.

(Step S506) The location information output unit 521 determines whether location information is included in the reception bit sequence input from the activation signal reception circuit 125. When the location information output unit 521 determines that the location information is included in the reception bit sequence input from the activation signal reception circuit 125, the procedure proceeds to a process of step S507. In other cases, the procedure proceeds to a process of step S509.

(Step S507) The location information output unit 521 outputs the location information, which is included in the reception bit sequence input from the activation signal reception circuit 125, to the cycle decision unit 122. Then, the procedure proceeds to a process of step S508.

(Step S508) The cycle decision unit 122 decides the operation cycle of the activation signal reception circuit 125 based on the location information input from the location information output unit 521 in the process of step S507, and an operation cycle table stored in the cycle storage unit 123. Then, the procedure proceeds to a process of step S509. A process of deciding the operation cycle of the activation signal reception circuit 125 is equal to the process described in the first embodiment.

(Step S509) The control unit 124 determines whether to end the procedure. For example, when the wireless communication unit 13 receives an end command from the data collection terminal 60, the control unit 124 determines to end the procedure. When the control unit 124 determines to end the procedure, the procedure is ended. In other cases, the procedure returns to the process of step S501.

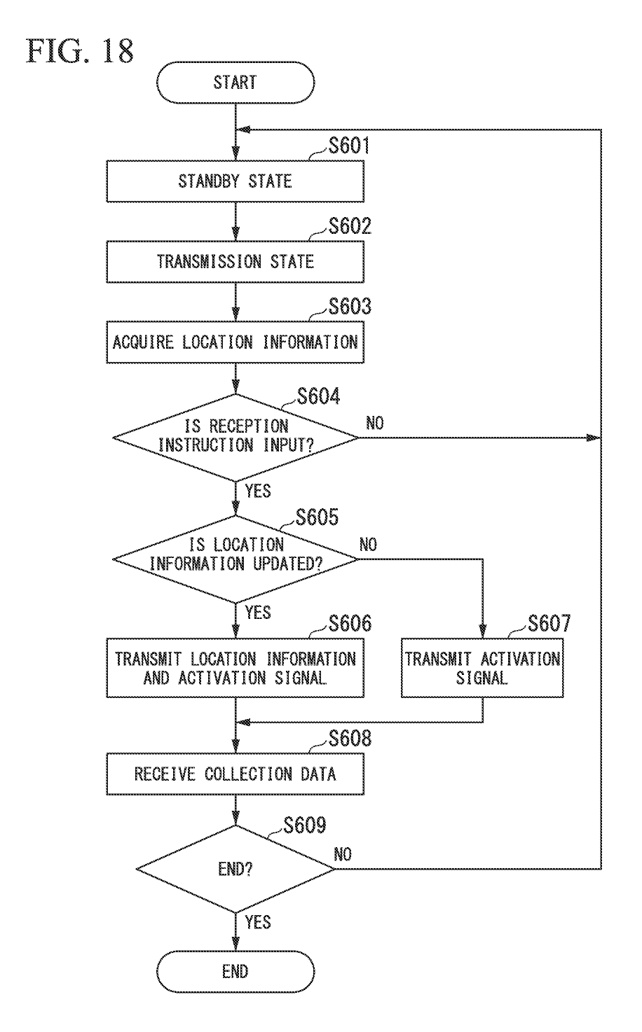

Next, the operation procedure of the data collection terminal 60 will be described. FIG. 18 is a flowchart illustrating the operation procedure of the data collection terminal 60 in the present embodiment.

(Step S601) The activation signal transmission circuit 22 operates in the standby state for a constant time. Then, the procedure proceeds to a process of step S602.

(Step S602) The activation signal transmission circuit 22 operates in the transmission state for a constant time. Then, the procedure proceeds to a process of step S603.

(Step S603) The location information acquisition unit 61 acquires the location information of its own terminal using GPS and the like, and outputs the location information, which indicates whether the current position of its own terminal is within the predetermined location range, to the activation signal transmission circuit 22. Then, the procedure proceeds to a process of step S604.

(Step S604) The activation signal transmission circuit 22 determines whether instruction input for receiving the collection data has been accepted. When the activation signal transmission circuit 22 determines that the instruction input for receiving the collection data has been accepted, the procedure proceeds to a process of step S605. In other cases, the procedure returns to the process of step S601.

(Step S605) The location information acquisition unit 61 determines whether the location information acquired in the process of step S603 is different from location information acquired in the process of a previous time. When the location information acquisition unit 61 determines that the location information acquired in the process of step S603 is different from the location information acquired in the process of the previous time, the procedure proceeds to a process of step S606. In other cases, the procedure proceeds to a process of step S607.

(Step S606) The activation signal transmission circuit 22 transmits the location information input from the location information acquisition unit 61 in the process of step S603, and the activation signal to the wireless sensing terminal 50 through the antenna 26. Then, the procedure proceeds to a process of step S608.

(Step S607) The activation signal transmission circuit 22 transmits the activation signal to the wireless sensing terminal 50 through the antenna 26. Then, the procedure proceeds to a process of step S608.

Processes of step S608 and step S609 are the same as the processes of step S205 and step S206 in the first embodiment.

As described above, according to the present embodiment, the wireless communication unit 13 provided in the wireless sensing terminal 50 operates in one of the first standby state of performing no transmission operation, and the first activation state of transmitting the collection data to the data collection terminal 60 different from its own terminal. Furthermore, after the transmission of the collection data is completed, the wireless communication unit 13 operates in the first standby state. Furthermore, the activation signal reception circuit 125 operates in one of the second standby state of performing no reception operation, and the second activation state of performing the reception operation, and repeats the operation in the second activation state and the operation in the second standby state at a predetermined time interval. Furthermore, in the case in which an activation signal is received from the data collection terminal 60 when operating in the second activation state, the activation signal reception circuit 125 outputs a shift signal for shifting the operation of the wireless communication unit 13 from the first standby state to the first activation state.

Furthermore, the data collection terminal 60 transmits the location information, which has been acquired by the location information acquisition unit 61 and indicates whether the current position of the data collection terminal 60 is within the predetermined location range, to the wireless sensing terminal 50. Furthermore, the cycle decision unit 122 of the wireless sensing terminal 50 changes the predetermined time interval, at which the activation signal reception circuit 125 repeats the operation in the second activation state and the operation in the second standby state, based on whether an estimation position of the data collection terminal 60 is within the predetermined location range. In detail, when the estimation position of the data collection terminal 60 is within the predetermined location range, the cycle decision unit 122 shortens the predetermined time interval at which the activation signal reception circuit 125 repeats the operation in the second activation state and the operation in the second standby state (sets the cycle as a short cycle). Furthermore, when the estimation position of the data collection terminal 60 is outside of the predetermined location range, the cycle decision unit 122 lengthens the predetermined time interval at which the activation signal reception circuit 125 repeats the operation in the second activation state and the operation in the second standby state (sets the cycle as a long cycle).

In this way, when the data collection terminal 60 is in the predetermined location range, it is possible to shorten the cycle in which the activation signal reception circuit 125 operates in the second activation state. Furthermore, when the data collection terminal 60 is not in the predetermined location range, it is possible to lengthen the cycle in which the activation signal reception circuit 125 operates in the second activation state. Furthermore, when the activation signal reception circuit 125 receives an activation signal from the data collection terminal 60, the wireless communication unit 13 performs transmission of the collection data. When the transmission of the collection data has been completed, the wireless communication unit 13 operates in the first standby state.

Consequently, when the position of the data collection terminal 60 is outside of the predetermined location range, the wireless sensing terminal 50 is possible to lengthen a time for which the activation signal reception circuit 125 operates in the second standby state. Thus, the wireless sensing terminal 50 is possible to reduce power consumption. For example, in the case in which the predetermined location range is set as a hospital or a house, when it is possible to estimate that the data collection terminal 60 is in a place other than a place at which a transmission operation of the collection data obtained in the hospital or the house is performed, the wireless sensing terminal 50 is possible to further reduce power consumption.

In the aforementioned example, the cycle decision unit 122 provided in the wireless sensing terminal 50 decides the operation cycle of the activation signal reception circuit 125 based on the location information transmitted from the data collection terminal 60. However, the present invention in not limited thereto. For example, the data collection terminal 60 includes the spot passage detection unit 321 to detect that its own terminal has passed through a predetermined spot and to output spot passage time information, which indicates a time at which the data collection terminal 60 has passed through the predetermined spot, to the wireless sensing terminal 50. Then, the cycle decision unit 122 of the wireless sensing terminal 50 may decide the operation cycle of the activation signal reception circuit 125 based on the spot passage time information transmitted from the data collection terminal 60, a current time, and the operation cycle table stored in the cycle storage unit 123. Furthermore, for example, the data collection terminal 60 includes the time information acquisition unit 421 to transmit time information indicating the current time to the wireless sensing terminal 50. Then, the cycle decision unit 122 of the wireless sensing terminal 50 may decide the operation cycle of the activation signal reception circuit 125 based on the time information transmitted from the data collection terminal 60, and the operation cycle table stored in the cycle storage unit 123.

### Fifth Embodiment

Next, a fifth embodiment of the present invention will be described with reference to the accompanying drawings. A biological monitoring system in the present embodiment includes a wireless sensing terminal 70 and a data collection terminal 80, similarly to the first embodiment.

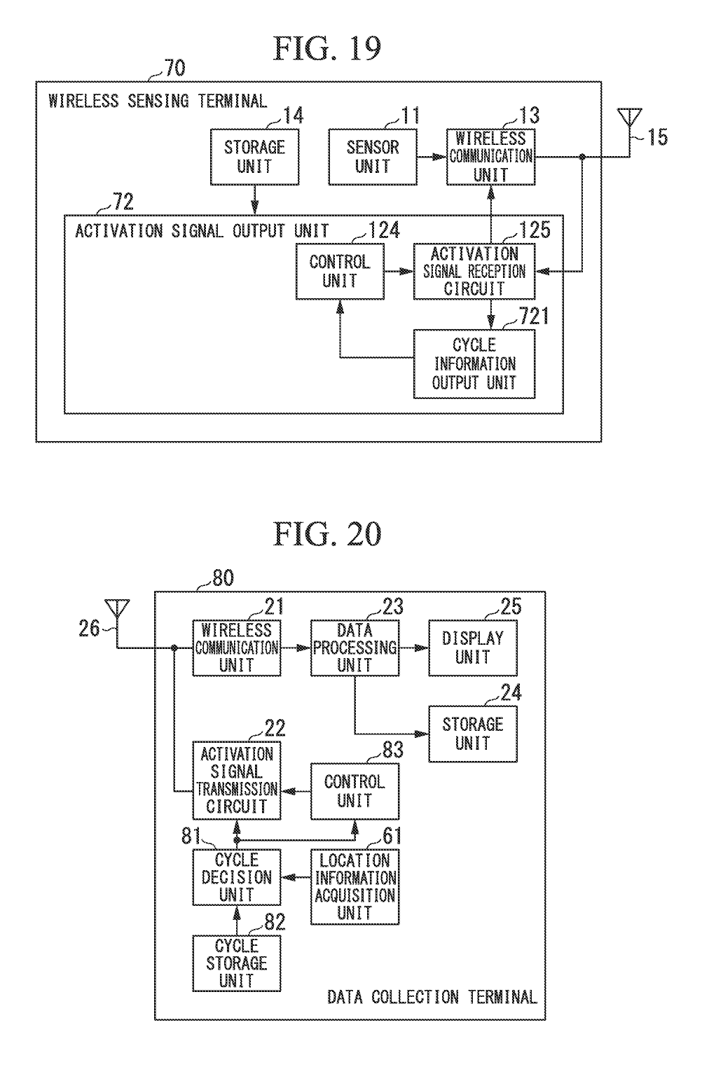

Next, the configuration of the wireless sensing terminal 70 will be described. FIG. 19 is a block diagram illustrating the configuration of the wireless sensing terminal 70 in the present embodiment. In the example illustrated in FIG. 19, the wireless sensing terminal 70 includes a sensor unit 11, an activation signal output unit 72, a wireless communication unit 13, a storage unit 14, and an antenna 15. The wireless sensing terminal 70 includes a battery (not illustrated). The battery supplies power to each element provided in the wireless sensing terminal 70.

The sensor unit 11, the wireless communication unit 13, the storage unit 14, and the antenna 15 are the same as those of the first embodiment. The activation signal output unit 72 includes a cycle information output unit 721, a control unit 124, and an activation signal reception circuit 125.

When a reception instruction signal is input from the control unit 124, the activation signal reception circuit 125 performs a reception operation for a given time. Then, the activation signal reception circuit 125 ends the reception operation and operates in the standby state (the second standby state). In this way, the activation signal reception circuit 125 is possible to repeat an operation in the state (the second activation state) of performing the reception operation and an operation in the second standby state at a constant cycle. Since the activation signal reception circuit 125 performs the reception operation when operating in the second activation state, power consumption of the activation signal reception circuit 125 is high when operating in the second activation state as compared with the case of operating in the second standby state. Furthermore, when data including a shift signal and a reception bit sequence which is transmitted from the data collection terminal 80 is received during the reception operation, the activation signal reception circuit 125 outputs the shift signal to the wireless communication unit 13, and outputs the reception bit sequence to the cycle information output unit 721.

When cycle information is included in the reception bit sequence input from the activation signal reception circuit 125, the cycle information output unit 721 outputs the cycle information to the control unit 124. The cycle information transmitted from the data collection terminal 80 is an operation cycle of the activation signal reception circuit 125. Based on the cycle information input from the cycle information output unit 721, the control unit 124 outputs a reception instruction signal to the activation signal reception circuit 125 and allows the activation signal reception circuit 125 to perform a reception process.

Next, the configuration of the data collection terminal 80 will be described. FIG. 20 is a block diagram illustrating the configuration of the data collection terminal 80 in the present embodiment. In the example illustrated in FIG. 20, the data collection terminal 80 includes a wireless communication unit 21, an activation signal transmission circuit 22, a data processing unit 23, a storage unit 24, a display unit 25, an antenna 26, a location information acquisition unit 61, a cycle decision unit 81, a cycle storage unit 82, and a control unit 83. The data collection terminal 80 includes a battery (not illustrated). The battery supplies power to each element provided in the data collection terminal 80.

The wireless communication unit 21, the data processing unit 23, the storage unit 24, the display unit 25, and the antenna 26 are the same as those of the first embodiment. The location information acquisition unit 61 acquires location information of its own terminal using GPS and the like, and outputs location information, which indicates whether a current position of its own terminal is within a predetermined location range, to the cycle decision unit 81. The predetermined location range may be decided in advance or arbitrarily set. For example, an inside of a hospital or a house is set as the predetermined location range.

The cycle decision unit 81 decides the operation cycle of the activation signal reception circuit 125 provided in the wireless sensing terminal 70 based on the location information input from the location information acquisition unit 61 and an operation cycle table stored in the cycle storage unit 82. Furthermore, the cycle decision unit 81 outputs cycle information indicating the decided operation cycle to the activation signal transmission circuit 22 and the control unit 83. The cycle storage unit 82 stores the operation cycle table indicating the operation cycle of the activation signal reception circuit 125 corresponding to the location information. Values of the operation cycle table may be decided in advance or arbitrarily set.

The operation cycle table of the present embodiment stores an operation cycle of m seconds as the operation cycle of the activation signal reception circuit 125 corresponding to location information indicating that a current position of its own device is within the predetermined location range. Furthermore, the operation cycle table stores in advance an operation cycle of n seconds as the operation cycle of the activation signal reception circuit 125 corresponding to location information indicating that the current position of its own device is outside of the predetermined location range. In this case, when the location information, input from the location information acquisition unit 61 indicates that the current position of its own device is within the predetermined location range, the cycle decision unit 122 decides the operation cycle of the activation signal reception circuit 125 as m seconds (a short cycle). Furthermore, when the location information input from the location information acquisition unit 61 indicates that the current position of its own device is outside of the predetermined location range, the cycle decision unit 122 decides the operation cycle of the activation signal reception circuit 125 as n seconds (a long cycle). The operation cycle of n seconds is longer than the operation cycle of m seconds. That is, the cycle decision unit 122 decides the operation cycle as a short cycle when the current position of its own device is within the predetermined location range, and decides the operation cycle as a long cycle when the current position of its own device is outside of the predetermined location range.

The control unit 83 holds two operation cycles of an operation cycle a used immediately before and transmitted to the wireless sensing terminal 70 and an operation cycle b decided by the cycle decision unit 81, outputs a transmission process instruction signal to the activation signal transmission circuit 22 at the timing of the operation cycle a, and allows the activation signal transmission circuit 22 to perform a transmission process. After the activation signal transmission circuit 22 completes the transmission process which will be described later, the control unit 83 writes the operation cycle b over the operation cycle a.

The activation signal transmission circuit 22 operates in one of a standby state and a transmission state in which power consumption is higher than that in the standby state. The activation signal transmission circuit 22 performs no process when operating in the standby state. In the case of operating in the transmission state in response to the transmission process instruction signal input from the control unit 83, when instruction input for receiving collection data has been accepted, the activation signal transmission circuit 22 transmits the cycle information input from the cycle decision unit 81 and an activation signal to the wireless sensing terminal 70 through the antenna 26. For example, when a transmission request button (not illustrated) provided in the data collection terminal 80 is pressed by a user, the activation signal transmission circuit 22 determines that the instruction input for receiving the collection data has been accepted. The activation signal transmission circuit 22 repeats an operation in the standby state and an operation in the transmission state at a constant cycle.

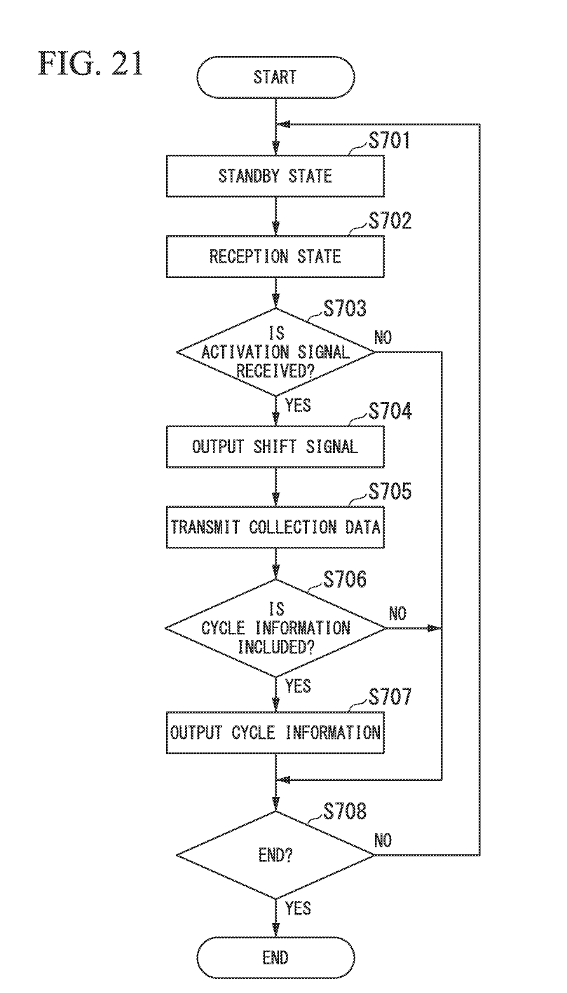

Next, an operation procedure of the wireless sensing terminal 70 will be described. FIG. 21 is a flowchart illustrating an operation procedure of the wireless sensing terminal 70 in the present embodiment.

(Step S701) The control unit 124 controls the activation signal reception circuit 125 to operate in the second standby state based on an operation cycle specified by the cycle information input from the cycle information output unit 721. In detail, the control unit 124 waits for a process for the operation cycle specified by the cycle information input from the cycle information output unit 721. Since a reception instruction signal is not input from the control unit 124, the activation signal reception circuit 125 operates in the second standby state. Then, the procedure proceeds to a process of step S702. When the cycle information is not input from the cycle information output unit 721 (when a process of step S707 is not performed), the control unit 124 controls the activation signal reception circuit 125 to operate in the second standby state based on the operation cycle of the long cycle.

(Step S702) The control unit 124 outputs the reception instruction signal to the activation signal reception circuit 125 based on the operation cycle specified by the cycle information input from the cycle information output unit 721, and allows the activation signal reception circuit 125 to perform a reception process. Since the reception instruction signal is input from the control unit 124, the activation signal reception circuit 125 operates in the second activation state. That is, the activation signal reception circuit 125 performs a reception operation. Then, the procedure proceeds to a process of step S703. When the cycle information is not input from the cycle information output unit 721, the control unit 124 controls the activation signal reception circuit 125 to operate in the second activation state based on the operation cycle of the long cycle.

(Step S703) The activation signal reception circuit 125 determines whether an activation signal has been received during the reception operation. When it is determined that the activation signal has been received during the reception operation, the procedure proceeds to a process of step S704. In other cases, the procedure proceeds to a process of step S708.

(Step S704) The activation signal reception circuit 125 outputs a shift signal to the wireless communication unit 13, and outputs a reception bit sequence to the cycle information output unit 721. Then, the procedure proceeds to a process of step S705.

(Step S705) Since the shift signal is input in the process of step S704, the wireless communication unit 13 transmits collection data, which has been input from the sensor unit 11, to the data collection terminal 80 through the antenna 15. Furthermore, after the transmission of the collection data is completed, the wireless communication unit 13 operates in the first standby state. Then, the procedure proceeds to a process of step S706.

(Step S706) The cycle information output unit 721 determines whether cycle information is included in the reception bit sequence input from the activation signal reception circuit 125. When the cycle information output unit 721 determines that the cycle information is included in the reception bit sequence input from the activation signal reception circuit 125, the procedure proceeds to a process of step S707. In other cases, the procedure proceeds to a process of step S708.

(Step S707) The cycle information output unit 721 outputs the cycle information, which is included in the reception bit sequence input from the activation signal reception circuit 125, to the control unit 124. Then, the procedure proceeds to a process of step S708.

(Step S708) The control unit 124 determines whether to end the procedure. For example, when the wireless communication unit 13 receives an end command from the data collection terminal 80, the control unit 124 determines to end the procedure. When the control unit 124 determines to end the procedure, the procedure is ended. In other cases, the procedure returns to the process of step S701.

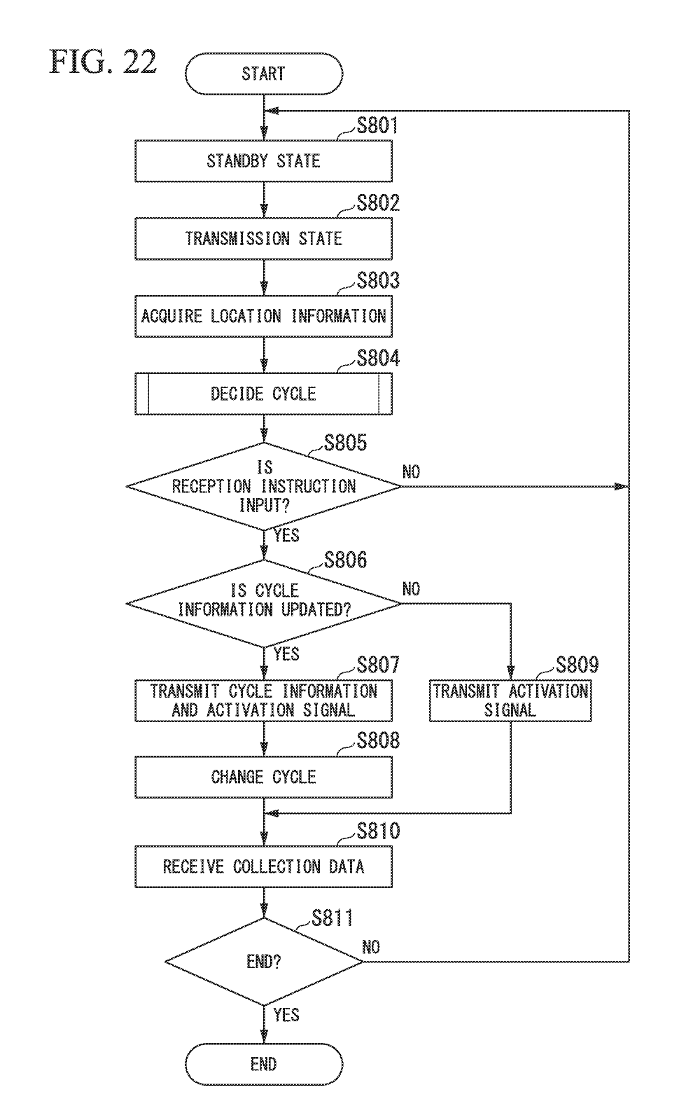

Next, the operation procedure of the data collection terminal 80 will be described. FIG. 22 is a flowchart illustrating the operation procedure of the data collection terminal 80 in the present embodiment.

(Step S801) The activation signal transmission circuit 22 operates in the standby state for a given time. Then, the procedure proceeds to a process of step S802.

(Step S802) The activation signal transmission circuit 22 operates in the transmission state for a given time. Then, the procedure proceeds to a process of step S803.

(Step S803) The location information acquisition unit 61 acquires the location information of its own terminal using GPS and the like, and outputs the location information, which indicates whether the current position of its own terminal is within the predetermined location range, to the cycle decision unit 81. Then, the procedure proceeds to a process of step S804.

(Step S804) The cycle decision unit 81 decides the operation cycle of the activation signal reception circuit 125 provided in the wireless sensing terminal 70 based on the location information input from the location information acquisition unit 61 in the process of step S803, and an operation cycle table stored in the cycle storage unit 82. Furthermore, the cycle decision unit 81 outputs the cycle information indicating the operation cycle of the activation signal reception circuit 125 to the activation signal transmission circuit 22. Then, the procedure proceeds to a process of step S805. A process of deciding the operation cycle of the activation signal reception circuit 125 is the same as the process described in the first embodiment.

(Step S805) The activation signal transmission circuit 22 determines whether instruction input for receiving the collection data has been accepted. When the activation signal transmission circuit 22 determines that the instruction input for receiving the collection data has been accepted, the procedure proceeds to a process of step S806. In other cases, the procedure returns to the process of step S801.

(Step S806) The cycle decision unit 81 determines whether the operation cycle of the activation signal reception circuit 125 decided in the process of step S804 is different from an operation cycle of the activation signal reception circuit 125 decided in a process of a previous time. When the cycle decision unit 81 determines that the operation cycle of the activation signal reception circuit 125 decided in the process of step S804 is different from the operation cycle of the activation signal reception circuit 125 decided in the process of the previous time, the procedure proceeds to a process of step S807. In other cases, the procedure proceeds to a process of step S809.

(Step S807) The activation signal transmission circuit 22 transmits the cycle information input from the cycle decision unit 81 in the process of step S804, and the activation signal to the wireless sensing terminal 70 through the antenna 26. Then, the procedure proceeds to a process of step S808.

(Step S808) After the transmission of the cycle information and the activation signal in the process of step S807 is completed, the control unit 83 changes an operation cycle of a process of a next time. Then, the procedure proceeds to a process of step S810.

(Step S809) The activation signal transmission circuit 22 transmits the activation signal to the wireless sensing terminal 70 through the antenna 26. Then, the procedure proceeds to a process of step S810.

Processes of step S810 and step S811 are the same as the processes of step S205 and step S206 in the first embodiment.

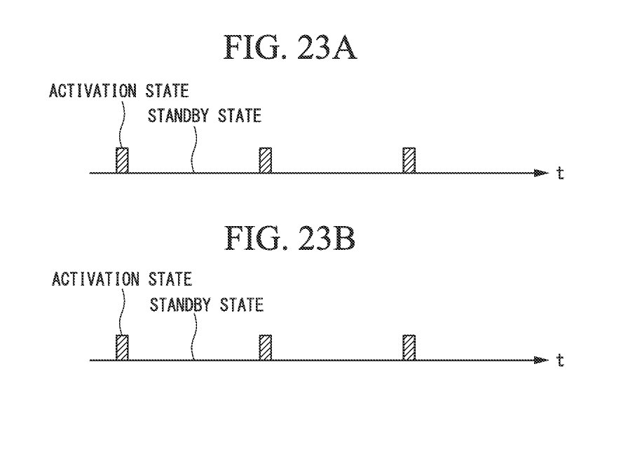

Next, a relation between a cycle of the second standby state and the second activation state of the activation signal reception circuit 125 provided in the wireless sensing terminal 70 and a cycle of the standby state and the transmission state of the activation signal transmission circuit 22 provided in the data collection terminal 80 will be described. In the present embodiment, a relation between a cycle of the second standby state and the second activation state when the operation cycle of the activation signal reception circuit 125 provided in the wireless sensing terminal 70 is a short cycle and a cycle of the standby state and the transmission state when the activation signal transmission circuit 22 provided in the data collection terminal 80 is a short cycle is the same as the relation illustrated in FIGS. 7A and 7B. FIGS. 23A and 23B are a timing chart illustrating a relation between a cycle of the second standby state and the second activation state when the operation cycle of the activation signal reception circuit 125 provided in the wireless sensing terminal 70 is a long cycle and a cycle of the standby state and the transmission state when the activation signal transmission circuit 22 provided in the data collection terminal 80 is a long cycle in the present embodiment.

The activation signal reception circuit 125 provided in the wireless sensing terminal 70 repeats the operation in the second standby state and the operation in the second activation state in response to the cycle decided by the cycle decision unit 81 provided in the data collection terminal 80. For example, when the cycle decision unit 81 provided in the data collection terminal 80 decides the operation cycle of the activation signal reception circuit 125 as a short cycle, the control unit 124 provided in the wireless sensing terminal 70 controls the operation state of the activation signal reception circuit 125 provided in the wireless sensing terminal 70 such that the operation cycle of the activation signal reception circuit 125 is equal to the cycle of the standby state and the transmission state of the activation signal transmission circuit 22 provided in the data collection terminal 80, as illustrated in FIGS. 7A and 7B. Furthermore, for example, when the cycle decision unit 81 provided in the data collection terminal 80 decides the operation cycle of the activation signal reception circuit 125 as a long cycle, the activation signal transmission circuit 22 provided in the data collection terminal 80 operates by setting the operation cycle as a long cycle as illustrated in FIG. 23A. Furthermore, as illustrated in FIG. 23B, the control unit 124 provided in the wireless sensing terminal 70 controls the operation state of the activation signal reception circuit 125 provided in the wireless sensing terminal 70 such that the operation cycle of the activation signal reception circuit 125 is equal to the cycle (the long cycle) of the standby state and the transmission state of the activation signal transmission circuit 22 provided in the data collection terminal 80.

In the example illustrated in FIGS. 23A and 23B, when the cycle decision unit 81 decides the operation cycle of the activation signal reception circuit 125 as a long cycle, the activation signal transmission circuit 22 provided in the data collection terminal 80 operates such that the operation cycle is twice as long as the short cycle. However, the present invention is not limited thereto. For example, it is sufficient if the cycle is longer than the short cycle.

As described above, according to the present embodiment, the wireless communication unit 13 of the wireless sensing terminal 70 operates in one of the first standby state of performing no transmission operation, and the first activation state of transmitting the collection data to the data collection terminal 80 different from its own terminal. Furthermore, after the transmission of the collection data is completed, the wireless communication unit 13 operates in the first standby state. Furthermore, the activation signal reception circuit 125 operates in one of the second standby state of performing no reception operation, and the second activation state of performing the reception operation, and repeats the operation in the second activation state and the operation in the second standby state at a predetermined time interval. Furthermore, in the case in which an activation signal is received from the data collection terminal 80 when operating in the second activation state, the activation signal reception circuit 125 outputs a shift signal for shifting the operation of the wireless communication unit 13 from the first standby state to the first activation state.

Furthermore, based on whether an estimation position of the data collection terminal 80 is within a predetermined location range, the cycle decision unit 81 provided in the data collection terminal 80 changes the predetermined time interval at which the activation signal reception circuit 125 provided in the wireless sensing terminal 70 repeats the operation in the second activation state and the operation in the second standby state. In detail, when the estimation position of the data collection terminal 80 is within the predetermined location range, the cycle decision unit 81 shortens the predetermined time interval at which the activation signal reception circuit 125 repeats the operation in the second activation state and the operation in the second standby state (sets the cycle as a short cycle). Furthermore, when the estimation position of the data collection terminal 80 is outside of the predetermined location range, the cycle decision unit 81 lengthens the predetermined time interval at which the activation signal reception circuit 125 repeats the operation in the second activation state and the operation in the second standby state (sets the cycle as a long cycle). Furthermore, the activation signal transmission circuit 22 provided in the data collection terminal 80 transmits cycle information indicating the predetermined time interval decided by the cycle decision unit 81 to the wireless sensing terminal 70. Furthermore, based on the cycle information transmitted from the data collection terminal 80, the control unit 124 provided in the wireless sensing terminal 70 controls a timing at which the activation signal reception circuit 125 operates in the second activation state, and a timing at which the activation signal reception circuit 125 operates in the second standby state.

In this way, when the data collection terminal 80 is in the predetermined location range, it is possible to shorten the cycle in which the activation signal reception circuit 125 operates in the second activation state. Furthermore, when the data collection terminal 80 is not in the predetermined location range, it is possible to lengthen the cycle in which the activation signal reception circuit 125 operates in the second activation state. Furthermore, when the activation signal reception circuit 125 receives an activation signal from the data collection terminal 80, the wireless communication unit 13 performs transmission of the collection data. When the transmission of the collection data has been completed, the wireless communication unit 13 operates in the first standby state.

Consequently, when the position of the data collection terminal 80 is outside of the predetermined location range, the wireless sensing terminal 70 is possible to lengthen a time for which the activation signal reception circuit 125 operates in the second standby state. Thus, the wireless sensing terminal 70 is possible to reduce power consumption. For example, in the case in which the predetermined location range is set as a hospital or a house, when it is possible to estimate that the data collection terminal 80 is in a place other than a place at which a transmission operation of the collection data obtained in the hospital or the house is performed, the wireless sensing terminal 70 is possible to further reduce power consumption.

In the aforementioned example, the cycle decision unit 81 provided in the data collection terminal 80 decides the operation cycle of the activation signal reception circuit 125 based on the location information transmitted from the location information acquisition unit 61. However, the present invention in not limited thereto. For example, the data collection terminal 80 includes the spot passage detection unit 321 to detect that its own terminal has passed through a predetermined spot and to output spot passage time information, which indicates a time at which the data collection terminal 80 has passed through the predetermined spot, to the cycle decision unit 81. Then, the cycle decision unit 81 may decide the operation cycle of the activation signal reception circuit 125 based on the spot passage time information input from the spot passage detection unit 321, a current time, and the operation cycle table stored in the cycle storage unit 82. Furthermore, for example, the data collection terminal 80 includes the time information acquisition unit 421 to transmit time information indicating the current time to the cycle decision unit 81. Then, the cycle decision unit 81 may decide the operation cycle of the activation signal reception circuit 125 based on the time information input from the time information acquisition unit 421, and the operation cycle table stored in the cycle storage unit 82.

So far, the first embodiment to the fifth embodiment of the present invention have been described in detail with reference to the accompanying drawings. However, detailed configurations are not limited to the embodiments, and a design and the like in the range not departing from the spirit of the present invention is included. For example, in the first embodiment to the fifth embodiment, the wireless sensing terminal and the data collection terminal wirelessly communicate with each other in a one-to-one manner. However, the present invention is applicable to relations of 1 to N, M to 1, and M to N (N and M are natural numbers).

The whole or a part of functions of each element provided in the wireless sensing terminal and the data collection terminal in the first embodiment to the fifth embodiment is recorded on a computer-readable recording medium in the form of a program for executing the functions. The program recorded on the recording medium may be read and executed by a computer system. The “computer system” herein is assumed to include an OS or hardware such as a peripheral device.

Furthermore, the “computer-readable recording medium” indicates a portable medium such as a flexible disk, a magneto-optical disc, a ROM, or a CD-ROM, and a storage unit such as a hard disk embedded in the computer system. Moreover, the “computer-readable recording medium” may include a medium for dynamically holding the program for a short time as with a communication line in the case of transmitting the program through a network such as the Internet or a communication line such as a telephone line, a medium for holding the program for a constant time as with a volatile memory in the computer system serving as a server or a client in that case. Furthermore, the program may include a program for executing a part of the aforementioned functions, or a program capable of executing the aforementioned functions through a combination of programs recorded on the computer system. So far, embodiments of the present invention have been described in detail with reference to the accompanying drawings. However, the present invention is not limited to the embodiments. The present invention may be subject to addition, omission, replacement, and other modifications of the configuration in a range not departing from the spirit of the present invention. The present invention is not limited to the above-mentioned description but is limited only by the accompanying claims.

What is claimed is:

1. A wireless communication apparatus comprising:
a communication module that operates in one of a first standby state and a first activation state in which power consumption is higher than power consumption in the first standby state, wirelessly transmits data to an external terminal different from its own terminal when operating in the first activation state, and operates in the first standby state after transmission of the data ends;
an activation signal generation unit that operates in one of a second standby state and a second activation state in which power consumption is higher than power consumption in the second standby state, repeats an operation in the second activation state and an operation in the second standby state at a predetermined time interval, and outputs a shift signal for shifting an operation of the communication module from the first standby state to the first activation state if an activation signal is received from the external terminal when operating in the second activation state; and
a cycle decision unit that changes the predetermined time interval based on location information indicating whether an estimation position of its own terminal or an estimation position of the external terminal is within a predetermined location range.

2. The wireless communication apparatus according to claim 1, further comprising:
an acquisition unit that acquires the location information,
wherein the cycle decision unit changes the predetermined time interval based on the location information acquired by the acquisition unit.

3. The wireless communication apparatus according to claim 2, wherein the acquisition unit acquires the location information from the external terminal.

4. The wireless communication apparatus according to claim 2, wherein the acquisition unit acquires the location information from the Global Positioning System.

5. The wireless communication apparatus according to claim 2, wherein the acquisition unit operates with power consumption is lower than power consumption of the communication module operating in the first activation state, detects presence of a predetermined apparatus, and acquires the location information based on a result of the detection.

6. The wireless communication apparatus according to claim 1, further comprising:
a cycle storage unit that stores time information corresponding to the location information as an operation cycle table,
wherein the cycle decision unit decides the location information based on the operation cycle table stored in the cycle storage unit and a current time.

7. A wireless communication system comprising:
a first communication module that operates in one of a first standby state and a first activation state in which power consumption is higher than power consumption in the first standby state, wirelessly transmits data to an external terminal different from its own terminal when operating in the first activation state, and operates in the first standby state after transmission of the data ends;
a first activation signal generation unit that operates in one of a second standby state and a second activation state in which power consumption is higher than power consumption in the second standby state, repeats an operation in the second activation state and an operation in the second standby state at a predetermined time interval, and outputs a shift signal for shifting an operation of the first communication module from the first standby state to the first activation state if an activation signal is received from the external terminal when operating in the second activation state;
a cycle decision unit that changes the predetermined time interval based on location information indicating whether an estimation position of its own terminal or an estimation position of the external terminal is within a predetermined location range;
a second communication module that receives the data transmitted by the first communication module; and
a second activation signal generation unit that transmits the activation signal to the first activation signal generation unit.

8. A wireless communication apparatus included in a wireless communication system including a first communication module that operates in one of a first standby state and a first activation state in which power consumption is higher than power consumption in the first standby state, wirelessly transmits data to an external terminal different from its own terminal when operating in the first activation state, and operates in the first standby state after transmission of the data ends, a first activation signal generation unit that operates in one of a second standby state and a second activation state in which power consumption is higher than power consumption in the second standby state, repeats an operation in the second activation state and an operation in the second standby state at a predetermined time interval, and outputs a shift signal for shifting an operation of the first communication module from the first standby state to the first activation state if an activation signal is received from the external terminal when operating in the second activation state, a cycle decision unit that changes the predetermined time interval based on location information indicating whether an estimation position of its own terminal or an estimation position of the external terminal is within a predetermined location range, a second communication module that receives the data transmitted by the first communication module, and a second activation signal generation unit that transmits the activation signal to the first activation signal generation unit, the wireless communication apparatus comprising:
the second communication module; and
the second activation signal generation unit.

9. The wireless communication apparatus according to claim 8, further comprising:
the cycle decision unit.

10. A wireless communication apparatus included in a wireless communication system including a first communication module that operates in one of a first standby state and a first activation state in which power consumption is higher than power consumption in the first standby state, wirelessly transmits data to an external terminal different from its own terminal when operating in the first activation state, and operates in the first standby state after transmission of the data ends, a first activation signal generation unit that operates in one of a second standby state and a second activation state in which power consumption is higher than power consumption in the second standby state, repeats an operation in the second activation state and an operation in the second standby state at a predetermined time interval, and outputs a shift signal for shifting an operation of the first communication module from the first standby state to the first activation state if an activation signal is received from the external terminal when operating in the second activation state, a cycle decision unit that changes the predetermined time interval based on location information indicating whether an estimation position of its own terminal or an estimation position of the external terminal is within a predetermined location range, a second communication module that receives the data transmitted by the first communication module, and a second activation signal generation unit that transmits the activation signal to the first activation signal generation unit, the wireless communication apparatus comprising:
the first communication module;
the first activation signal generation unit; and
the cycle decision unit.

11. A wireless communication method comprising:
a communication step in which a communication module operates in one of a first standby state and a first activation state in which power consumption is higher than power consumption in the first standby state, wirelessly transmits data to an external terminal different from its own terminal when operating in the first activation state, and operates in the first standby state after transmission of the data ends;
an activation signal generation step in which an activation signal generation unit operates in one of a second standby state and a second activation state in which power consumption is higher than power consumption in the second standby state, repeats an operation in the second activation state and an operation in the second standby state at a predetermined time interval, and outputs a shift signal for shifting an operation of the communication module from the first standby state to the first activation state if an activation signal is received from the external terminal when operating in the second activation state; and
a cycle decision step in which a cycle decision unit changes the predetermined time interval based on location information indicating whether an estimation position of its own terminal or an estimation position of the external terminal is within a predetermined location range.

12. A wireless communication method comprising:
a first communication step in which a first communication module operates in one of a first standby state and a first activation state in which power consumption is higher than power consumption in the first standby state, wirelessly transmits data to an external terminal different from its own terminal when operating in the first activation state, and operates in the first standby state after transmission of the data ends;
a first activation signal generation step in which a first activation signal generation unit operates in one of a second standby state and a second activation state in which power consumption is higher than power consumption in the second standby state, repeats an operation in the second activation state and an operation in the second standby state at a predetermined time interval, and outputs a shift signal for shifting an operation of the first communication module from the first standby state to the first activation state if an activation signal is received from the external terminal when operating in the second activation state;
a cycle decision step in which a cycle decision unit changes the predetermined time interval based on location information indicating whether an estimation position of its own terminal or an estimation position of the external terminal is within a predetermined location range;
a second communication step in which a second communication module receives the data transmitted by the first communication module; and
a second activation signal generation step in which a second activation signal generation unit transmits the activation signal to the first activation signal generation unit.

13. A computer-readable recording medium recording a program for causing a computer to execute:
a communication step in which a communication module operates in one of a first standby state and a first activation state in which power consumption is higher than power consumption in the first standby state, wirelessly transmits data to an external terminal different from its own terminal when operating in the first activation state, and operates in the first standby state after transmission of the data ends;
an activation signal generation step in which an activation signal generation unit operates in one of a second standby state and a second activation state in which power consumption is higher than power consumption in the second standby state, repeats an operation in the second activation state and an operation in the second standby state at a predetermined time interval, and outputs a shift signal for shifting an operation of the communication module from the first standby state to the first activation state if an activation signal is received from the external terminal when operating in the second activation state; and
a cycle decision step in which a cycle decision unit changes the predetermined time interval based on location information indicating whether an estimation position of its own terminal or an estimation position of the external terminal is within a predetermined location range.

14. A computer-readable recording medium recording a program for causing a computer to execute:
a first communication step in which a first communication module operates in one of a first standby state and a first activation state in which power consumption is higher than power consumption in the first standby state, wirelessly transmits data to an external terminal different from its own terminal when operating in the first activation state, and operates in the first standby state after transmission of the data ends;
a first activation signal generation step in which a first activation signal generation unit operates in one of a second standby state and a second activation state in which power consumption is higher than power consumption in the second standby state, repeats an operation in the second activation state and an operation in the second standby state at a predetermined time interval, and outputs a shift signal for shifting an operation of the first communication module from the first standby state to the first activation state if an activation signal is received from the external terminal when operating in the second activation state;
a cycle decision step in which a cycle decision unit changes the predetermined time interval based on location information indicating whether an estimation position of its own terminal or an estimation position of the external terminal is within a predetermined location range;
a second communication step in which a second communication module receives the data transmitted by the first communication module; and
a second activation signal generation step in which a second activation signal generation unit transmits the activation signal to the first activation signal generation unit.
